(19) United States
(12) Patent Application Publication
(10) Pub. No.: US 2008/0140760 A1
(43) Pub. Date: Jun. 12, 2008

(54) Service-oriented architecture system and methods supporting dynamic service provider versioning

(76) Inventors: Peter A. Conner, Rocklin, CA (US); Eric M. Greenfeder, Fort Collins, CO (US); David F. Woldrich, Portland, OR (US)

Correspondence Address: GERALD B ROSENBERG;NEW TECH LAW, 260 SHERIDAN AVENUE, SUITE 208, PALO ALTO, CA, 94306-2009, US

(21) Appl. No.: 11/900,193

(22) Filed: Sep. 10, 2007

Related U.S. Application Data
(63) Continuation-in-part of application No. 11/388,624, filed on Mar. 21, 2006.
(60) Provisional application No. 60/664,250, filed on Mar. 21, 2005.

(51) Int. Cl. G06F 15/16

(52) U.S. Cl. 709/201

(57) ABSTRACT

Versioning of the business operation methods implemented by service providers within a distributed computer system implementing a service oriented-architecture is performed by maintaining, with respect to a collection of deployed service providers, a versioning database storing data representing the sets of version identifiers defined for the individual business operation methods of the service requester interfaces and service providers. The data further includes mapping data defining mapping compatible correspondences between select business operation method identifiers of the service requester interfaces and service providers. A request identifying a service requester interface produces a result identification of service providers compatible with the business operation method requirements of the service requester interface based on a determination of a mapping compatible correspondence between business operation method identifiers of the service requester interface and each resultant identified service provider.

### BACKGROUND OF THE INVENTION

1. Field of the Invention

The present invention is generally related to distributed data processing systems implementing service-oriented architectures and, in particular, to a distributed computer system infrastructure enabling dynamic management of dynamically versioned services within the cooperative organization and operation of a service-oriented architecture.

2. Description of the Related Art

The integrated data processing requirements of diversified, complex, and large-scale business operations, characteristically arising from commercial competitiveness and dynamic change demands, have and will continue to drive the evolution of the information technology (IT) systems needed to implement and manage the business information services required by those operations. Typical operations where complex business information services are required include banking, finance and related accountancy operations, supply-chain management for retail, manufacturing and redistribution operations, and customer relationship management for service and sales organizations. For each, the underlying data relations and automated business processes that capture, integrate, maintain, analyze, and utilize those relations represent an intricate and extensive domain expertise that can be highly specific to an individual organization. Existing business information service systems, often realized as a constellation of third-party and custom software applications, typically represent heavy investments in licensing, installation, consulting, and custom tailoring to meets the particular needs of an organization. The internal complexity of these systems is compounded by the requirement for scaling without loss of performance. In many practical instances, system scale is measured in terms of hundreds to thousands of computer systems, thousands to tens of thousands of users, and terabytes of data held and processed on a daily if not hourly basis.

Of the different data processing architectures potentially suitable for organizing and integrating complex, large-scale business information systems, the service-oriented architecture (SOA) has attracted substantial attention. The design benefits of SOA typically enumerated include agility, flexibility, and manageability. In summary, agility refers to the desired architectural design capability of enabling quick implementation of new, often complex business processes and rapid refinement and extension of existing business processes to accommodate evolving business requirements. Flexibility refers to the design capability of enabling development, incorporation and use of new service components as well as ready adaptation of existing service components and legacy applications, wherever they may exist, all within an often complex, distributed network environment. Manageability refers to the design capability of readily accommodating the life-cycle change requirements of components, applications, and the overall business information service system in a coordinated, cost-effective and verifiably reliable manner.

In practice, a service-oriented architecture is not defined by a singular design, but rather encompasses a strategic collection of design practices that share a substantial degree of implementation mutuality in the environment of a distributed data processing system, such as generally illustrated in FIG. 1. In typical circumstances, a distributed computer system 10 includes various network 12 interconnected, often heterogeneous computer platforms, operating as servers 14, 16, 18, supporting similarly varied clients 20, 22. Fundamental to SOA design practices is the focused use of distinct, modular business information services as the de-constructed elements of the business information service system used to support end-users of the client platforms 20, 22. Through various sequences of procedural composition and orchestration of the modular services wherever resident on the server platforms 14, 16, 18, desired business processes can be readily implemented and subsequently evolved. By preferring definition of multiple autonomous services, flexibility in realizing different business information service processes is enhanced. By further stressing separation of concerns in conjunction with modularity, the resulting loose-coupling between service components enhances adaptability and reusability due to the reduction of operational interdependencies within and between services. Such discretely modularized services are also easier to implement, modify, test and verify operationally.

In the context of a service-oriented architecture, the various service components and applications that provide data processing services are generically referred to as service providers. A service provider is characteristically defined by a defined, invocable interface allowing access to a specific provided data processing function or closely related set of functions. The service interface exposes these service functions within the scope of the business information services system. Individual components may be originally designed and implemented to function as service providers. Service interfaces can also be constructed from otherwise existing, or legacy, components and applications through the addition of one or more service interfaces.

Architecturally, service providers are accessed through service consumers, also generally referred to as service requesters. Service consumers characteristically operate to expose a well-defined business information service interface, directly or indirectly, to external users. The exposed service interface is functionally implemented by reliance on an underlying service provider or, more typically, some functional composition or orchestration of multiple service providers. Desirably, the business information service supported by exposed interface of the service consumer is relatively course-grained and otherwise opaque relative to the underlying service providers. The exposed service is accessed by an application or other user, directly or though reliance on a network command and data transfer protocol. Standard web services protocols, such as Simple Object Access Protocol (SOAP) and Representational State Transfer (REST) can be used. Messaging protocols, such as Java Message Service (JMS), Java Connector Architecture (JCA), Service Component Architecture (SCA), and Java Platform, Enterprise Edition (J2EE) are also used. A service consumer can also implement a structured document server in order to support hypertext (HTTP) and other extensible markup language (XML) based protocols. Application specific and other proprietary network protocols may also be implemented as needed.

As illustrated in FIG. 2, conventional SOA implementations 30 employ an enterprise service bus (ESB) 32 as a middleware layer interconnecting disparate service consumers 34_{1-N} and service providers 36_{1-M}. Like the term service-oriented architecture, the term enterprise service bus does not define a specific design, but rather references a complement of related features and functions characteristically provided in conjunction with a network-based, messaging layer. In typical implementation, an enterprise service bus 32 implements a messaging fabric hosting a varied complex of function-added components 38, including requisite service requester adapters 40_{1-N} and service provider adapters 42_{1-M}, as well as protocol converters, routing and event controls, and performance management and monitoring instrumentation. Distributed service consumers 34_{1-N} and providers 36_{1-M} can then, at least from an architectural point of view, uniformly connect to and through the ESB 32 utilizing a consistent integration pattern to implement the various business processes necessary to collectively implement the desired distributed business services system 10.

The service adapters 40_{1-N}, 42_{1-M} of conventional ESBs expose network protocol-specific interfaces appropriate to functionally match corresponding business service interfaces of the different specific service consumers 34_{1-N} and service providers 36_{1-M}. An ESB-based service registry 44 is typically employed in the design-time construction of the adapters to record and support design-time discovery of adapter protocol requirements and determine adapter interface definitions. At run-time then, the service adapters 40_{1-N}, 42_{1-M} are effectively dedicated, based on protocol and interface, to specific service consumers 34_{1-N} and service providers 36_{1-M}. The network locations of service requester adapters 40_{1-N} and service providers 36_{1-M} are encoded at design-time into the paired service consumers 34_{1-N} and service provider adapters 42_{1-M}.

The basic function of conventional ESBs is to route messages, representing network protocol specific requests and responses, between the service adapters 40_{1-N}, 42_{1-M}. Perhaps the principal additional function of an ESB 32 is the performance of network protocol conversion. Since the service consumers 34_{1-N} and service providers 36_{1-M} may communicate with their service adapters 40_{1-N}, 42_{1-M} using entirely different protocols, the SOA goals of agility and flexibility requires the ESB 32 to provide protocol transparency between the service adapters 40_{1-N}, 42_{1-M} and thereby prevent the undesirable coupling of adapter parings. ESBs therefore conventionally implement a typically complex complement of mapping, transform, and protocol converter components 38 internal and integral to the switching fabric of the ESB 32. Thus, as network messages are routed between service adapters 40_{1-N}, 42_{1-M}, the conversion for any specific pairing of service consumers 34_{1-N} and service providers 36_{1-M} can be determined and applied. Support for proprietary protocols is both required and accommodated by an ESB 32 through the inclusion of a proprietary protocol specific adapter and corresponding set of proprietary protocol converters.

Other embedded component functions frequently provided by conventional ESBs include support for asynchronous messaging, alternate and enhanced message routing capabilities, standardized authorization, authentication and audit controls including interfaces to external standard LDAP services, and various rule-based and schema-based message validation services. Conventional ESBs may internally implement or functionally associate a business process modeling (BPM) engine with the ESB. In typical implementation, the BPM engine is a business-rule driven, executable component used to implement complex business processes. A gateway interface provides access to the required multiple service providers 36_{1-M}. The process logic defined by the business-rules sequences functional composition and orchestration of service providers 36_{1-M}, accessed directly and indirectly through other service requesters 34_{1-N}, as required to implement the desired business process.

In real-world SOA implementations, the design as well as practical benefits of utilizing an ESB are such that ESBs are conventionally considered to be a fundamental if not inherent SOA implementation requirement. In particular, the architecturally centralized design pattern of implementing both standard and proprietary service adapters 40_{1-N}, 42_{1-M} coupled with the routed inclusion of protocol converters is both effective and efficient. The conventional alternative of tightly coupling service requesters to service providers fails to attain let alone maintain the agility and flexibility of an SOA/ESB implementation. With an ESB, service consumers 34_{1-N} and service providers 36_{1-M}, including their specific service adapters and any corresponding proprietary protocol converters, can be independently added and removed from the SOA implementation with relative ease. Another particular benefit of an ESB-based design is the conventionally considered essential ability of the ESB to monitor and audit all messaging transactions in a consistent manner. The centralized routing control enables this essential service for conventional SOA manageability.

Even with the many benefits of ESB-based SOA implementations, significant difficulties remain. In particular, conventional ESBs have evolved into quite complex network communications components. At a basic level, an ESB itself provides no directly visible business value while requiring substantial investments in development, licensing, and operational management, as well as run-time computing resources. The centralized service architecture of an ESB, being essentially a message routing hub, naturally constrains the scalability of conventional ESB implementations and inherently introduces a performance sensitive coupling into all ESB operations. Naturally, network message throughput is a critical concern in all practical SOA implementations. Performance optimization in particular and basic validation of service component operation in general is made particularly difficult by the inclusive nature of the ESB architecture. Given the broad set of service adapters, converters, and other embedded components all jointly implemented in an ESB, the discrete identification and correction of functional and performance problems are difficult.

Another problem with conventional ESB implementations arises from the difficulty of managing change in a system implemented using an SOA design. Given the typical scale of SOA-based systems, offline maintenance is undesirable. Due to the relatively monolithic nature of a conventional ESB, the introduction of adapter modifications required to support changed service consumers and service providers in an active operating environment without any service error or interruption is technically and procedurally complex. Even where possible, the centralized, interdependent operation of the ESB does not readily support transitional change management or qualified verification of changes in an operating business information services system. Consequently, the agility and flexibility desirable in an SOA design are significantly compromised, if not lost, due to the undesirable level of risk inherent in applying changes to an operational SOA system.

While not a problem unique to SOA systems, another difficulty arises from the increasingly dynamic nature of distributed computing systems and, in particular, those desirable to be used to execute service providers. Grid computing, virtualization and related technologies are in active development to provide greater platform, performance, and management flexibility in the execution of service components and applications. Dynamic replacement, relocation and even the mere restarting of a service provider can have significant consequences on the proper and intended operation of a SOA-based system. In general, such issues are beyond the consideration of conventional ESB implementations.

Consequently, a need exists for an improved implementation infrastructure for service-oriented architecture systems.

### SUMMARY OF THE INVENTION

Thus, a general purpose of the present invention is to provide an improved distributed computer system infrastructure enabling an efficient direct invocation of services, subject to dynamic versioning, within the cooperative organization of a service-oriented architecture.

This is achieved in the present invention by providing a system and methods of versioning of the business operation methods implemented by service providers within a distributed computer system implementing a service oriented-architecture by maintaining, with respect to a collection of deployed service providers, a versioning database storing data representing the sets of version identifiers defined for the individual business operation methods of the service requester interfaces and service providers. The data further includes mapping data defining mapping compatible correspondences between select business operation method identifiers of the service requester interfaces and service providers. A request identifying a service requester interface produces a result identification of service providers compatible with the business operation method requirements of the service requester interface based on a determination of a mapping compatible correspondence between business operation method identifiers of the service requester interface and each resultant identified service provider.

An advantage of the present invention is that, within a distributed computer system implementing a service-oriented architecture enabling service requesters to directly communicate with service providers, versioning and redeployment of service providers can be performed dynamically at run-time essentially transparent to the ongoing operation of service requesters. The significance of version changes at an individual business operation method level can be autonomously evaluated and appropriate sets of service providers determined for different service requesters based on the different business operation requirements of the individual service requesters.

Another advantage of the present invention is that relative compatibility of individual business operation methods, as required by service requesters and supported by service providers, is encoded as business operation method identifiers. A repository can store the different sets of business operation method identifiers representing the individual service requesters and service providers and, thereby, support system-wide resolution of version compatible service requesters and service providers.

A further advantage of the present invention is that mapping information is determined and stored for version compatible associations of business operation method identifiers. The mapping information, representing some combination of mapping, translation and conversion data, is determinable for each pairing of different versions of a business operation method required by a service requester and supported by a service provider, where the different versions are version compatible.

Still another advantage of the present invention is that an identification of a business operation method and relative version compatibility can be encoded into a business operation method identifier. Collections of business operation method identifiers can be used to separately define service requester and service provider instances. Matching of business operation method identifiers, subject to a mutual relative compatibility determination, enables identification of functionally compatible service requesters and service providers and, further, selection of the sets of mapping information that can enable functional compatibility.

### BRIEF DESCRIPTION OF THE DRAWINGS

FIG. 1 illustrates a preferred distributed data processing operating environment within which embodiments of the present invention can be effectively utilized.

FIG. 2 is a block diagram providing a representational view of a conventionally implemented service-oriented architecture employing an enterprise service bus.

FIG. 3 is a simplified block diagram of a preferred embodiment of the present invention illustrating a functionally local implementation of service invocation frameworks and functionally direct communications between service requesters and service providers.

FIG. 4A provides a block diagram view of a service requester as constructed in accordance with a preferred embodiment of the present invention.

FIG. 4B is provides a block diagram view of a service provider as constructed in accordance with a preferred embodiment of the present invention.

FIG. 5 is a block diagram of a preferred embodiment of the present invention illustrating a flexible, multi-tiered implementation of service requesters and service providers including adaption to a legacy enterprise service bus.

FIG. 6 is a detailed block diagram illustrating the operational association between a service requester, a service invocation manager, and service provider manager in accordance with a preferred embodiment of the present invention.

FIGS. 7A and 7B are block diagrams illustrating the interoperation of a service invocation manager in managing access by service requesters to service providers in accordance with a preferred embodiment of the present invention.

FIG. 8 is a detailed block diagram illustrating the interoperation of a service invocation manager and a service provider manager, including service provider adapters, for monitoring the status and operation of service platforms in accordance with a preferred embodiment of the present invention.

FIG. 9 is a simplified sequence diagram illustrating the selection and generation of meta-data in connection with the construction of a service invocation framework-based service requester in accordance with a preferred embodiment of the present invention.

FIG. 10 is a simplified sequence diagram illustrating the deployment of a new or modified service provider in accordance with a preferred embodiment of the present invention.

FIG. 11 is a simplified sequence diagram illustrating the run-time initialization of a service invocation framework of a service requester and the business service data transfer request and response communications between the service requester and service provider using the service invocation framework in accordance with a preferred embodiment of the present invention.

FIG. 12 is a simplified block diagram illustrating the operation of a service mapping engine within the service invocation manager in accordance with a preferred embodiment of the present invention.

FIG. 13 is a simplified sequence diagram illustrating the interoperation of a service invocation framework and service invocation manager to provide for the run-time initialization and update of the service invocation framework in accordance with a preferred embodiment of the present invention.

FIG. 14 is a simplified sequence diagram illustrating the monitoring of a virtual machine monitor for the location management of service providers in accordance with a preferred embodiment of the present invention.

FIG. 15 is a simplified sequence diagram illustrating the change management interoperation of the service invocation manager and service invocation frameworks of affected service requesters in accordance with a preferred embodiment of the present invention.

FIG. 16 is a simplified sequence diagram illustrating the depreciation management interoperation of the service invocation manager and service invocation frameworks of affected service requesters in accordance with a preferred embodiment of the present invention.

FIG. 17 is a simplified sequence diagram illustrating the capture and analysis of metrics reflective of business method call and return operations between service requesters and service providers in accordance with a preferred embodiment of the present invention.

### DETAILED DESCRIPTION OF THE INVENTION

In the practical implementation of complex business information service systems, the use of service-oriented architectures, including the foundational use of enterprise service buses, is broadly accepted. As recognized in connection with the present invention, certain architectural and performance improvements are desirable provided that the substantial benefits of SOA, particularly including those afforded through the use of an ESB, are maintained. The present invention accordingly presents a new SOA system infrastructure architecture that functionally eliminates conventional ESBs in favor of an efficient, direct service invocation infrastructure framework fully compliant with SOA design principals. As will be appreciated, in the following detailed description of the preferred embodiments of the present invention, like reference numerals are used to designate like parts as depicted in one or more of the figures.

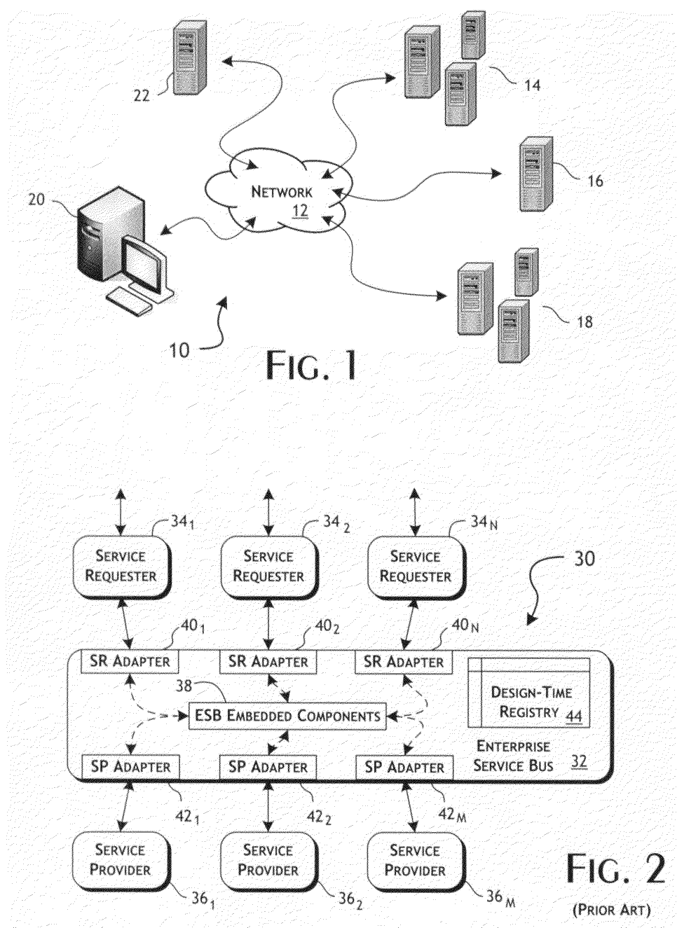

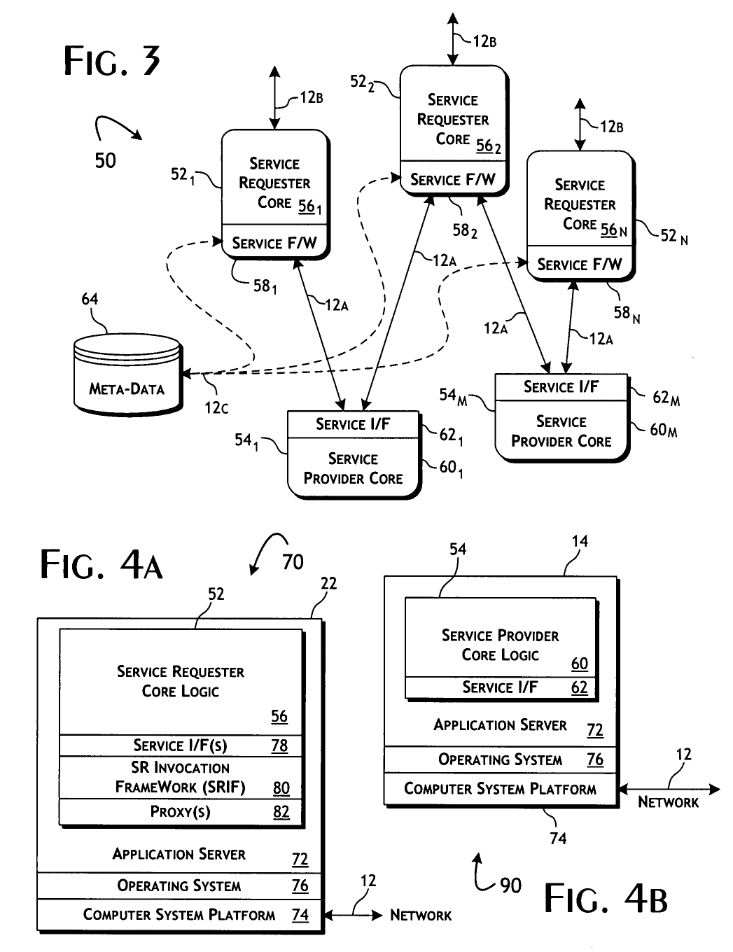

A distributed data processing system 10 environment suitable for the implementation of embodiments of the present invention is shown in FIG. 1. Server computer platforms and platform clusters 14, 16, 18, which may be and typically are heterogenous in terms of operating systems and construction, are interconnected through any combination of private intranets, virtual private networks, and public internet connections 12 with personal and workstation computer systems 20 directly or interoperating through other client oriented computer systems 22 acting as dedicated application servers. In accordance with the present invention, service requesters and service providers may be resident and executed anywhere within the distributed data processing system 10 though, in typical implementations, service providers are more commonly hosted on servers platforms 14, 16, 18 while service requesters are hosted on any potentially user-facing platform including the servers platforms 14, 16, 18 and particularly the client platforms 20, 22.

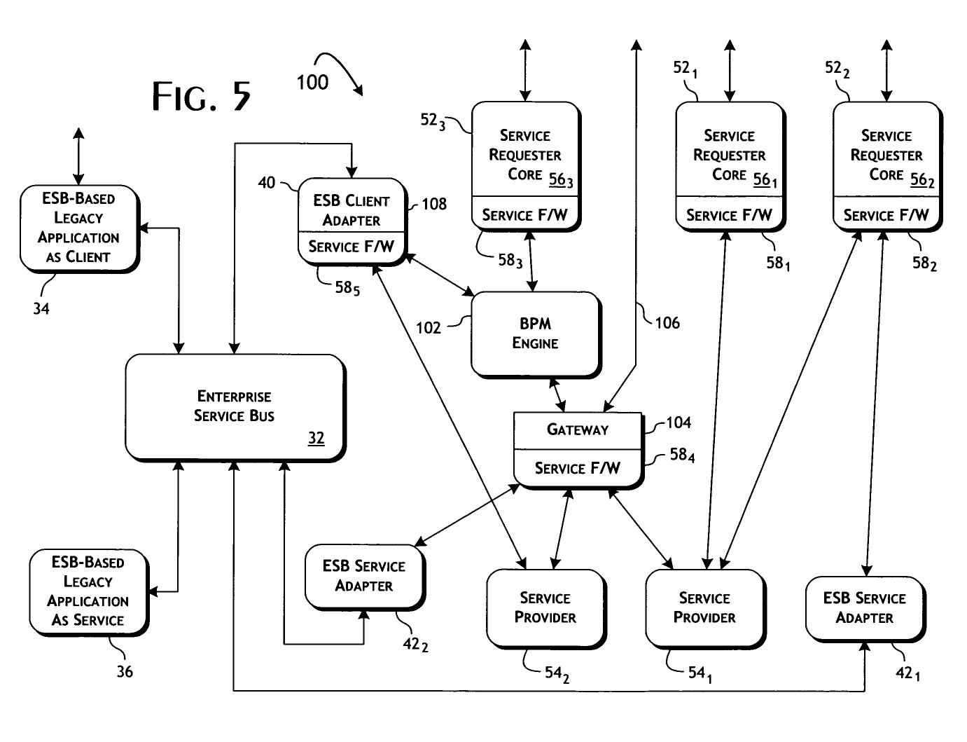

Referring to FIG. 3, a preferred embodiment of the direct service invocation infrastructure framework architecture 50 is shown. In utilizing the distributed service invocation framework architecture 50, service requesters 52_{1-N} are able to establish functionally direct network communications sessions on-demand with one or more service providers 54_{1-M} over a network 12A typically in response to client-side or other network business operation requests received by the service requesters 52_{1-N} through a network 12B. The networks 12A and 12B represent in any combination instances, segments, or subnets of the same or different networks 12. For purposes of the preset invention, functionally direct network communications encompasses the various conventional forms of routing, packet data and network protocol transforms characteristic of different network systems, such as Ethernet, Asynchronous Transfer Mode (ATM), and the like, without requirement of transiting a conventional enterprise service bus.

In implementing the distributed service invocation framework architecture 50 of the present invention, the service requesters 52_{1-N} each implement service requester core logic components 56_{1-N} that communicate through service invocation framework components 58_{1-N} with one or more of the service providers 54_{1-M}. Consistent with the preferred embodiments of the present invention, each of the service requester core logic components 56_{1-N} represents an executable software component designed to perform some designated business logic operation. In preferred implementation, the core logic components 56_{1-N} can be realized as relatively large-scale legacy applications or units of business logic of simple to substantial complexity executed as components within in an application server.

The service invocation framework components 58_{1-N} are preferably executed in conjunction with the service requester core logic components 56_{1-N} sufficient to enable and perform local communications with the service requester core logic components 56_{1-N}. For purposes of the present invention, local communications are defined by use of any communications mechanism not employing a transaction over a physical network connection. Such communications mechanisms include, for example, local method calls, local thread calls, shared memory references, interprocess communications, virtual network communications, application program interface (API) calls, reflection-based invocation of APIs, and the like. Execution of the service invocation framework components 58_{1-N} preferably implements the specific set of message and protocol conversions, mappings, transforms, and translations necessary to enable service requester core logic component 56_{1-N} communications with the precise set of one or more of the service providers 54_{1-M} required to support the function of a particular service requester core logic component 56_{1-N}.

Preferably, the service providers 54_{1-M} implement service provider core logic components 60_{1-M} and service provider interfaces 62_{1-M}. The service provider core logic components 60_{1-M} are executable software components designed to perform a provider oriented business service operation, such as realized by relatively large-scale legacy applications, implemented as business specific custom applications and industry specific customizable applications, including for example, SAP, Oracle Financials, and Siebel CRM, or units of business service logic of simple to substantial complexity utilized to access and process data obtained from various sources, such as databases. The service provider interfaces 62_{1-M} preferably expose WSDL (W3C Web Services Definition Language) compliant service interfaces to enable invocation by the service invocation framework components 58_{1-N}. These service provider interfaces 62_{1-M} may be implemented, for example, using any of the several different web service (WS) implementations, session Enterprise JavaBeans (EJB), a Java Message Service (JMS), or using a Java 2 Enterprise Edition (J2EE) Connector (J2C) adapter. Other interfaces, particularly including legacy application specific interfaces, may be provided as the service provider interfaces 62_{1-M} directly or built over with an otherwise conventional web services or similar interface layer. Service invocation involves application of a request to a service provider interface 62_{1-M} for a particular business service operation to be performed by the underlying service provider core logic component 60_{1-M} on behalf of a request originating service requesters 52_{1-N}. The form and format of the request are dependent on the functional interface binding exposed by a service provider interface 62_{1-M}.

In accordance with the present invention, the service invocation framework components 58_{1-N} support and enable dynamic, run-time binding of service requesters 52_{1-N} to service providers 54_{1-M}. Binding, in this context, includes resolving a functional identification of a service provider 54_{1-M} to an instance location, web service or other protocol selection, mappings appropriate to convert between the form and format of business method calls and business service invocations, and the data conversions and translations needed to support the mappings. Preferably, dynamic binding is implemented by the service invocation framework components 58_{1-N} based on functional identifications of service providers 54_{1-M} contained, preferably through construction, in the service requester core logic components 56_{1-N}. These functional identifications, as determined at design-time, represent the one or more service providers 54_{1-M} required to implement the business operations of the corresponding service requester core logic components 56_{1-N}. At run-time, the functional service providers 54_{1-M} identifications are resolved and implemented by the service invocation framework components 58_{1-N} as run-time bindings enabling functionally direct communications between specific, not necessarily exclusive, pairings of service requesters 52_{1-N} and service providers 54_{1-M}.

In the preferred embodiments, the information necessary to resolve the run-time bindings for particular service provider interfaces 62_{1-M} is obtained from a meta-data store 64, accessible through a network 12C similar in nature to the networks 12A and 12B. The retrieved information preferably identifies the network location and protocol information necessary to communicate service invocations and corresponding responses with service providers 54_{1-M} of the named type and the implementation versions of those service providers 54_{1-M}. The retrieved information further preferably identifies the business method mappings, conversions and translations required to match the form and format of the service invocations originated by a specific service requester core logic component 56_{1-N} specifically with those of the exposed service provider interface 62_{1-M} of the named service provider 54_{1-M}. In alternate embodiments of the present invention, WSDL bindings for a named service provider 54_{1-M} may be retrieved discretely from the meta-data store 64 or other Universal Description Discovery and Integration (UDDI) registry accessible through the network 12. The information stored by the meta-data store 64 is preferably developed at design-time in connection with service providers 54_{1-M} and thereafter used to support the complementary development of service requester core logic components 56_{1-N}.

A service requester 52, constructed in accordance with a preferred embodiment of the present invention for execution on an application server system, such as server 22, is shown in FIG. 4A. An execution environment is provided by a conventional application server 72, such as WebSphere® Application Server™ v6.1, a commercial product of IBM Corp., or JBoss® Application Server™, a commercially supported product of Red Hat, Inc. The application server 72 is executed on a conventional server computer system platform 74 in conjunction with a conventional operating system 76, such as Red Hat Enterprise Linux 5, a commercially supported product of Red Hat, Inc.

Multiple service requesters 52 can be executed within the application server 72. For the preferred embodiments of the present invention, each service requester 52 includes a service requester core logic component 56, one or more service interface stubs 78, a service requester invocation framework (SRIF) component 80, and one or more dynamically incorporated service proxy classes 82. As implemented in the preferred Java programming language, each service interface stub 78 is a class compiled with the service requester core logic component 56 to provide the service requester core logic component 56 with a business method call interface corresponding to a service provider 54 as specified by a unique interface identifier. Separate service interface stubs 78 are provided for each functionally distinct service provider 54 required to implement the business operation of the service requester core logic component 56. The service interface stub 78 is preferably derived at design-time from meta-data store 64 information representing the WSDL binding defined for the corresponding service interface 62. Preferably, each service interface stub 78 will functionally implement a business method call interface by, on demand, marshaling a called method name and parameters and invoking the service requester invocation framework component 80. The business method call interface of a service interface stub 78 may appropriately represent a subset of the business operations implemented by a service provider core logic component 54 where the additional implemented operations are not required by the particular service requester core logic component 52.

The service requester invocation framework component 80 preferably functions, based on configuration meta-data, to dynamically evaluate and implement business method name and parameter mappings, conversions, and translations, appropriate to the service provider 54 intended to implement the business method call of the service requester core logic component 56. In some instances, the mapping may be one-to-one with no required conversions. In other instances, significant mappings, conversions, and translations may be required. Configuration meta-data preferably specifies the required mapping of method signatures, including parameter types, and return data type and further specify the data type conversions and data format translations required to transform between the business method calls originated by a service requester core logic component 56 and the business method bodies ultimately implemented by a corresponding service provider core logic component 60. Preferably, default configuration meta-data is incorporated into the service requester invocation framework component 80 at design-time and, further, can be updated at run-time from the meta-data store 64 to enable dynamic adaptation of the service requester invocation framework component 80. The preferred implementation of the service requester invocation framework components 80 is as an ordinary Java object or as a formal EJB co-executed with the service requester core logic component 56 as a local resource within the application server 72. Where realized as an ordinary Java object, a one-to-one instance relationship is used. Where realized as an EJB, multiple service requester core logic components 56, with respective sets of service interface stubs 78, may utilize a single EJB service requester invocation framework component 80.

The service requester invocation framework component 80 also preferably hosts one or more service proxy classes 82, with each service proxy class 82 functioning as a communications channel between the service requester invocation framework component 80, on behalf of a corresponding service interface stub 78, and a communications protocol service supported by the application server 72. The specific communications protocol service support implemented will depend on the communications protocol supported by the service provider 54 that implements the desired business method operation. Preferably, proxy classes 82 are constructed dynamically, dependent on a run-time identification of a particular service interface stub 78 and service provider 54 instance, further based on an evaluation of the WSDL or other binding specification of the service interface 62 as obtained from the meta-data store 64. Thus, a business method call made through a service proxy class 82, representing a business method call made through the service interface stub 78 as further adapted by the service requester invocation framework component 80, results in a business method service invocation of the service interface 62 and return of any applicable response.

In the preferred embodiments of the present invention, service proxy classes 82, as constructed, also encapsulate the network location and network messaging protocol configuration information ultimately used by the application server 72 in establishing a communications session with a service provider 54. The network location may be specified by a set of one or more universal resource identifiers (URIs) or other reference values that can be resolved by the application server 72 to particular prioritized or redundant service provider 54 instances.

A service provider 54, constructed in accordance with a preferred embodiment of the present invention for execution on a server computer system, such as server 14, is shown in FIG. 4B. An application server 72 provides an execution environment for the service provider core logic component 60 and supports network access to the service interface 62. The application server 72 is executed on a conventional server computer system platform 74 in conjunction with a conventional operating system 76.

An expanded architectural embodiment 100 of the direct service invocation infrastructure framework architecture 50 is shown in FIG. 5. The expanded architecture 100 illustrates the ability of the present invention to effectively support multiple tiers of service providers 54 and service requesters 52 and the ready incorporation of business support and legacy components, directly and through a legacy enterprise service bus 32. As shown, a service requester 52₁, including a service requester core logic component 56₁, utilizes a service invocation framework component 58₁ to establish a direct invocation of a service provider 54₁.

A second service requester 52₂ illustrates the ability of a single service requester core logic component 56₂ to composite multiple service providers through a single service invocation framework component 58₂. As shown, the business service operation provided by the service provider 54₁ is separately accessible by the service requesters 52₁, 52₂. A second service provider is also accessible directly by the service requester 52₂. As here shown for purposes of generality, this second service provider is provided by a legacy service provider indirectly accessed through an ESB service provider adapter 42₁. Preferably, the service provider adapter 42₁ implements an exposed interface functionally equivalent to the service provider interfaces 62 with the conventional adapter logic implemented as the service provider core logic component 60. While the ESB service provider adapter 42₁ thus appears as a directly invocable service provider 54 to the service requester 52₂, the adapter logic operates to exchange the invocation calls and responses through the ESB 32 to a conventional ESB connected service provider, such as a legacy application service provider 36, paired by the ESB 32 with the service provider adapter 42₁.

A third service requester 52₃ further illustrates the consistently defined multiple tiering capability of the present invention. As shown, the service requester core logic component 56₃ is configured, through the local service invocation framework component 58₃, to directly invoke a service provider 54 that may further operate as a service requester 52, thereby establishing a multiply tiered relationship. In a preferred embodiment, the logically combined service requester/service provider is constructed with a business process modeling engine 102 substituted as the service provider core logic component 60, a gateway layer 104, and service invocation framework component 58₄. The BPM engine 102 preferably supports a service provider interface 62 characteristic of service providers 54. The gateway interface 104 preferably incorporates one or more service interface stubs 78 selected appropriate for the needs of the BPM engine 102, acting in the role of a service requester, in orchestrating business service operations provided by an underlying tier of service providers 54. The provision of service invocation framework component 58₄ to enables the BPM engine 102, acting through the gateway interface 104, to perform as a service requester 52. The underlying tier of service providers 54 can include simple service providers, such as the service provider 54₂, ESB service provider adapters 42₂, and other service requesters 52 accessed as service providers, such as the service requester 52₂, that expose a network 12B accessible interface functionally equivalent to the service provider interfaces 62. Additionally, the gateway 104 can also implement a service provider interface 62 that allows legacy service requesters, for example remotely distributed SOAP clients 106, to access the underlying tier of service providers 54 fully consistent with the present invention.

The direct service invocation infrastructure framework architecture 50 of the present invention also enables ESB service requesters 34 to access and utilize service providers 54. As shown, an ESB service requester adapter 40 is functionally implemented as the service requester core logic component 56 of an ESB adapted service requester 108. The requester adapter 40 is preferably constructed with one or more service interface stubs 78 enabling interoperation with a local service invocation framework component 58₅. Business method calls transferred through the ESB 32 are then mapped, converted, and translated, as appropriate, by the service invocation framework component 58₅ into business service invocations directed to corresponding service providers 54 or, as generally shown, the BPM engine 102.

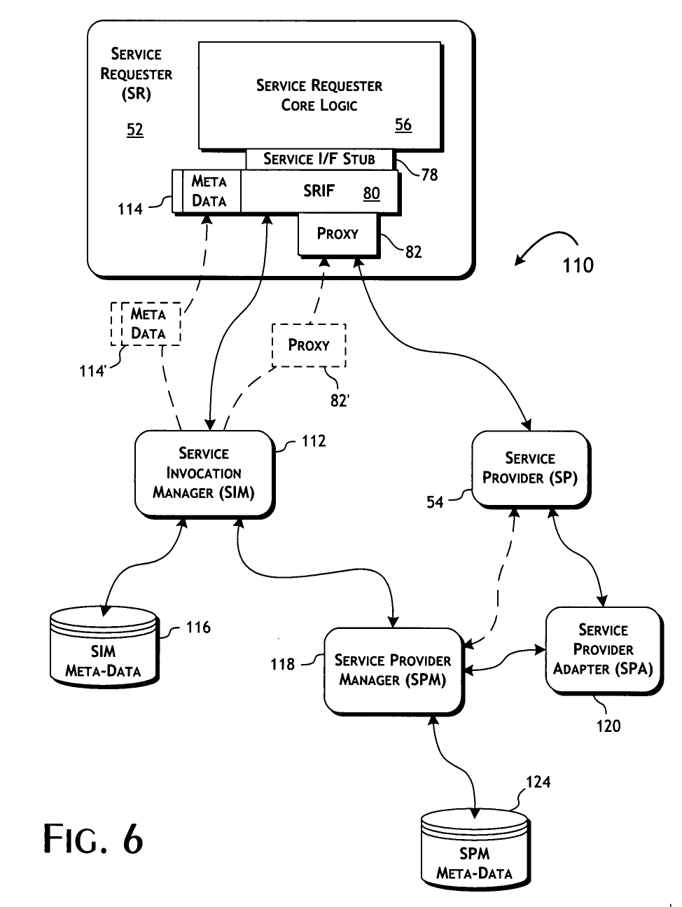

A preferred infrastructure architecture 110, provided to support the dynamic operation of direct service invocation infrastructure framework architecture 50, is shown in FIG. 6. For the preferred embodiments of the infrastructure architecture 110, a service invocation manager (SIM) 112 is provided to source configuration SIM meta-data 114′ and service proxy classes 82 to service requesters 52. In the preferred embodiment, either or both configuration SIM meta-data 114′ and service proxy classes 82 are requested upon initialization and subsequent reinitializations of the service requester invocation framework component 80. Service proxy classes 82′ are preferably generated un-configured. Configuration meta-data 114′ is provided to initially configure and subsequently reconfigure the service requester invocation framework component 80. Similarly, a portion of the configuration meta-data 114′ is preferably provided to configure newly delivered service proxy classes 82′ or re-configure existing service proxy classes 82.

The configuration meta-data 114′ and service proxy classes 82′ are preferably derived from SIM meta-data 116 stored in a persistent repository accessible by the service invocation manager 112. Preferably, a service interface identifier compiled into a service interface stub 78 is used by the service invocation manager 112 to select relevant portions of the SIM meta-data 116 necessary to compose instances of the meta-data 114′ and service proxy class 82′ specific to the service interface identifier.

The composition of the meta-data 114′ and service proxy class 82′ is also dependent on run-time availability of service providers 54. A service provider manager (SPM) 118 preferably provides for the run-time initiation of services providers 54 and, further, preferably monitors the continuing operating state of the service providers 54. The monitoring of service providers 54 is performed either direct or through various service provider adapters (SPA) 120 that support management interaction with specific monitored service providers 54 and associated execution environments. State and related information concerning available service providers 54 is preferably stored as SPM meta-data 124 accessible by the service provider manager 118.

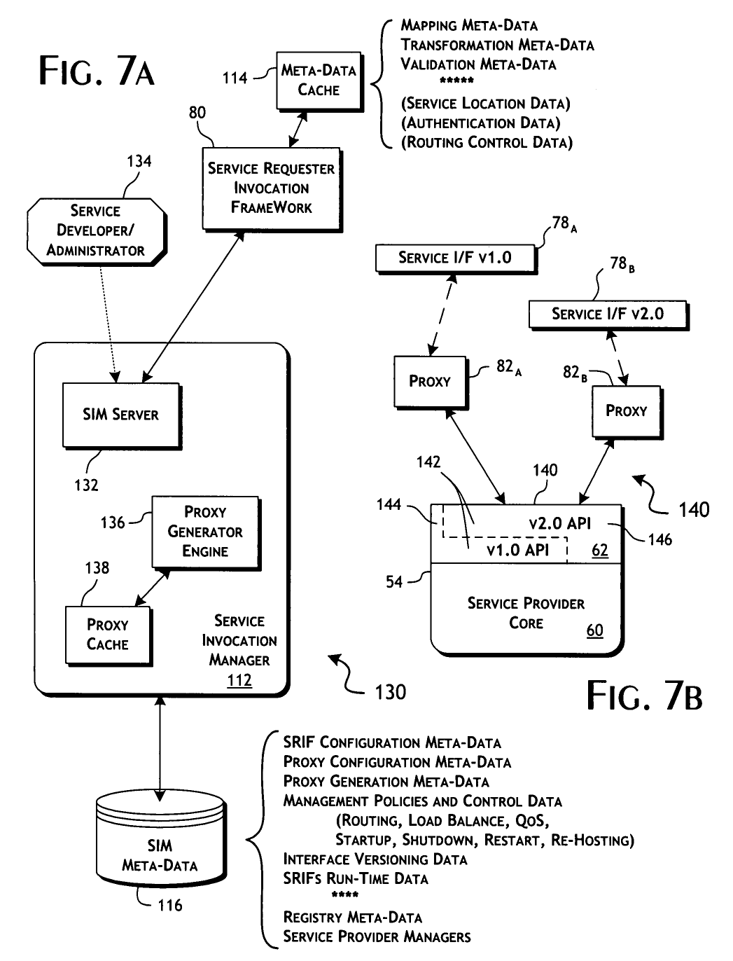

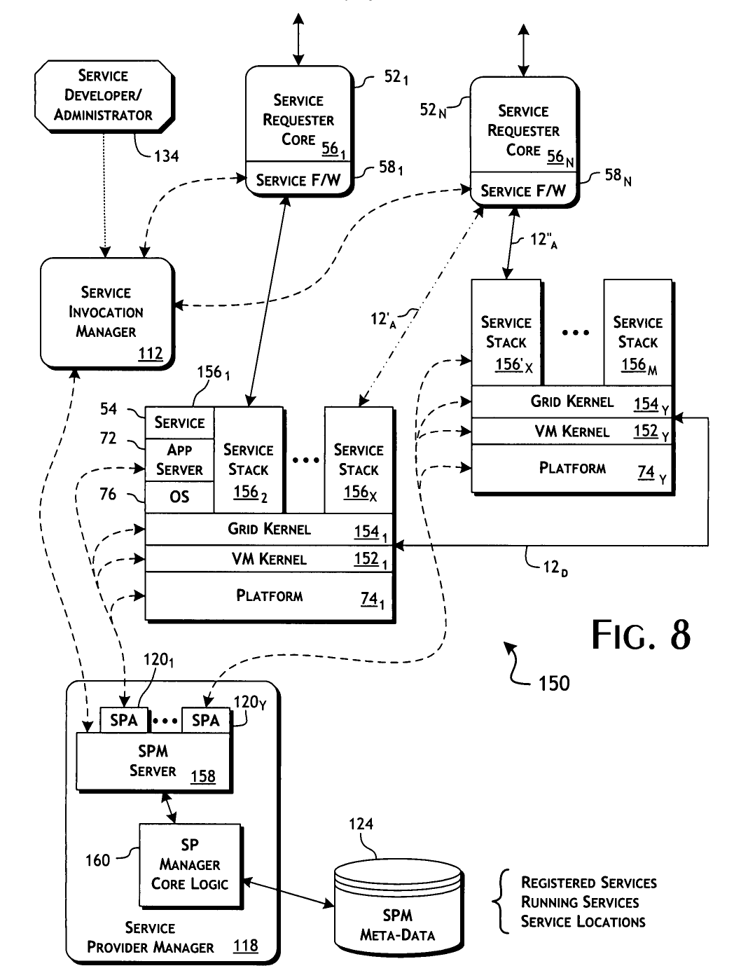

A preferred embodiment 130 of the infrastructure architecture 110 is illustrated in FIG. 7A. The service invocation manager 112 includes a SIM server 132, implemented using a conventional application server, preferably a J2EE-compliant application server implementing REST and web services interfaces, such as Apache Geronimo, JBoss® Application Server™, IBM WebSphere™, and BEA WebLogic™. The SIM server 132 enables network access by developers 134 at design-time and administrators at run-time to the service invocation manager 112 and SIM meta-data store 116 that implements, in the preferred embodiments, aspects of one or more databases. WSDL bindings created in conjunction with the individual service providers 54 are processed and incorporated into an aspect of the SIM meta-data store 116 for use in subsequent development of service requesters 52. The principal SIM meta-data is described in Table 1.

TABLE 1
SIM Meta-Data

| Data | Description |
|---|---|
| SRIF Run-Time: | Network location, typically URLs, and related |
| | status and network access information for the |
| | various service requesters within the SOA |
| | system scope to enable run-time SIM directed |
| | management of the SRIFs. |
| SRIF Configuration: | Copies of the current run-time configuration |
| | meta-data held by the various SRIFs/service |
| | proxies within the SOA system scope managed |
| | by the SIM. |
| Proxy Generation: | Control information used in the automated |
| | resolution of business method call mapping, |
| | data type conversion, and data translation, |
| | enabling run-time construction of a proxy |
| | class given specific service stub and |
| | business service interface instances. |
| Proxy Configuration: | Rules defining the selection and pre- |
| | configuration of information into a generated |
| | proxy class. |
| Routing Control: | Rules governing load-balancing for selection |
| | between service provider instances of the same |
| | type; rules governing priority path routing and |
| | alternate path selection; rules governing re- |
| | try and fail-over. |
| Versioning Control: | General version definition and progression |
| | rules; detailed incompatibility information |
| | for specific service provider versions. |
| Registry: | Network location, typically URL, and preferred |
| | access priority of the network SRIF registries. |
| Service Provider Mgr: | Network location, typically URLs, and related |
| | use information for the various service |
| | provider managers within the SOA system scope. |
| Quality of Service: | Rules defining threshold levels for quality of |
| | service and fall-back and fail-over actions. |
| Routing Control: | Prioritized set of route control information |
| | defining retry and fail-over path selection |
| | operations. |

In the preferred embodiments of the present invention, the service invocation manager responds to SRIF configuration requests issued by specific service requester invocation framework 80 instances and received by the SIM server 132. SRIF configuration requests are issued on initialization and reinitialization of the corresponding service requester 52. A default network location value is included in service requester invocation framework 80 instance to at least enable discovery of the service invocation manager 112 during run-time initialization of the service requester 52. During run-time, the service invocation manager 112 can direct a service requester invocation framework 80 instance to issue an SRIF configuration request, typically by sending a reinitialization command to the service requester invocation framework 80. The network location and related access information necessary for the service invocation manager to communicate with specific service requester invocation framework 80 instances are maintained in the SIM meta-data store 116.

In response to an SRIF configuration request, the service invocation manager typically generates and forwards a service proxy class 82′ and configuration meta-data 114′ to the requesting service requester invocation framework 80 instance. A proxy generator engine 136 generates service proxy classes 82′ for each of the service interface stubs 78 identified by the SRIF configuration request. The proxy generator engine 136 operates by analyzing and generating code to functionally interconnect the respective version specific interfaces defined by a service interface stub 78 and a service provider interface 62. Mapping information obtained from the SIM meta-data store 116 is used to define correspondences between method signatures, conversion information is used to define parameter position and data types conversions, and translation information defines the required parameter and return data translations. The generated code is compiled to class object implementing the required service proxy class 82′. A proxy cache 138 is preferably provided to reduce otherwise redundant generation of proxy classes 82′.

In the preferred embodiment of the present invention, the service proxy classes 82′ are generated with programmable data structures to permit inclusion of redefineable configuration data within the class object structure. These data storage structures, as detailed in Table 2, are further preferably specific to the establishment and operation of the particular communication session that will be conducted through a service proxy class 82.

TABLE 2
Service Proxy Class Configuration Data

| Data | Description |
|---|---|
| Service Providers: | Network locations, preferably URLs, identifying a |
| | prioritized list of service providers that can be used |
| | by this service proxy class. |
| Network Protocols: | Configuration data to further define and control the |
| | network messaging protocol implicitly selected for |
| | use by the run-time generated encoding of the |
| | proxy class object. |
| Validation Data: | Configuration data to validate a communication |
| | session with an intended service provider instance. |

Separate meta-data 114′ is preferably provided to the service requester invocation framework components 80 to define operation of a specific service requester invocation framework 80 instance relative to all of the service proxy classes hosted by the instance and relative to the service invocation manager 112. The meta-data 114′ preferably includes the network location of the service invocation manager 112, typically specified by a URL, and authentication data to validate communications with that service invocation manager 112. The locations of multiple service invocation managers 112 can be included to support fail-over and load-balancing operation. Where a service requester invocation framework 80 component is reinitialized without providing a new service proxy class 82′, the meta-data 114′ is preferably used to supply the configuration information that will be updated to the internal data structures of the existing service proxy class 82 by operation of the associated service requester invocation framework 80 component. Configuration data not stored in service proxy class 82 is preferably stored in a meta-data cache 114 data structure within the service requester invocation framework 80 component. In alternate embodiments of the present invention, configuration data can be provided to the service requester invocation framework components 80 variously divided between a service proxy class 82′ and meta-data 114′.

The direct service invocation infrastructure framework architecture 50 of the present invention enables dynamic, run-time configuration and reconfiguration to support versioning and other changes made to service providers 54. Versioning of a service provider 54 occurs on revision of some combination of the service provider core logic component 60 and service invocation interface 62. For purposes of the present invention, such revisions can be categorized as implementation, interface, and semantic changes. Implementation, interface, and semantic changes are, in the preferred embodiments of the present invention, defined against the individual interface method calls implemented by the service provider core logic component 60. An interface change is a breaking change in the definition of the service invocation interface 62. An implementation change occurs on modification of the underlying operation of the service provider core logic component 60 that does not change the functional operation of the business operation implemented. A semantic change represents a change in the intended functional operation of the implemented business operation. A semantic change is a breaking change even in the absence of an interface change. Preferably, a developer will distinguish simple non-breaking implementation changes from breaking semantic changes in the course of revising a service provider core logic component 60. Interface changes can be automatically detected and marked as breaking changes.

As exemplarily shown in FIG. 7B, a first service invocation interface 62, denoted v1.0 API, is subsequently versioned to establish a second service invocation interface 62, denoted v2.0 API 140. The v1.0 API is, as shown, subsumed as part 142 of the v2.0 API, though a portion 144, representing one or more business method calls, is deprecated. The v2.0 API revision also makes available a number of new business method calls 146 relative to the v1.0 API. Whether the revision to the v2.0 API for the individual business method calls exposed 140 by the service invocation interface 62 represents interface, implementation, or semantic changes will depend on the corresponding detailed nature of the changes made to the service invocation interface 62 and the underlying implementation routines of the service provider core logic component 60. As evident, the versioning of a particular service provider 54 can and, in practice, will result in the run-time availability of multiple service provider 54 variants offering different interface, performance, resource, and semantic capabilities. While the preferred goal is to only have instances of one variant of a service provider 54 executing at run-time, decommissioning of prior version instances is constrained by service requester 52 dependencies.

In accordance with the present invention, existing service requesters 52 implementing, for example, v1.0 API service interface stubs 78_{A} need not be concurrently revised and, potentially, not even restarted in order to remain compatible with and use service provider 54 instances implementing a versioned v2.0 API. Interruption is not required in the absence of breaking change. Provided the particular subset of business method calls used in support of the business operations required by a service provider 54 remain exposed 140 and not semantically changed, even if deprecated, unchanged use of the service interface stub 78A and proxy 82A is possible. Where a required business method call is subject to an interface change, the service requester invocation framework components 80 of the service requesters 52 implementing v1.0 API service interface stubs 78_{A} need only be reinitialized to receive a dynamically constructed mapping between the calls represented by the v1.0 API service interface stub 78_{A} and exposed 140 v2.0 API service invocation interface 62 and, as appropriate, a replacement service proxy class 82_{A}. Service requesters directly implementing v2.0 API service interface stubs 78_{B} receive and use service proxy classes 82_{B} that implements the necessary, typically one-to-one service interface stub 78 to service invocation interface 62 mapping. Where a particular service provider 54 is revised to include a semantic change, the using service requesters 52 can be restarted with proxy classes 82 that select direct communication with other unrevised executing instances of the service provider 54. Alternately, the service requester core logic component 56 of the service requester 52 must be correspondingly revised, necessitating an interruption in service, to operate with service providers implementing the semantic change. In the preferred embodiments of the present invention, currently executing service requesters 52 are preferably restarted with updated mappings and proxy classes 82A whenever the underlying service provider 54 is revised to include an interface or implementation change, typically to benefit from performance or management considerations related to the service provider 54 revision. In accordance with the present invention, the separate, selective provision of mapping meta-data and service proxy classes 82_{A}, 82_{B} precludes concurrent use conflicts between service requesters 52 implementing differently versioned service interface stubs 78_{A}, 78_{B}. Versioning of the service provider 54 is therefore operationally transparent to the direct and higher tiers of service requesters 52 that access the service provider 54.

For the preferred embodiments of the present invention, the preferred service provider 54 version identification scheme assigns a service provider version identifier to each service provider 54 as the basis for determining the interoperation requirements of the specific service provider 54 instance. The instance specific service provider version identifier is preferably coded into the service invocation interface 62 of the service providers 54. The preferred service provider version identifier is of the form sID.M.N, where
sID identifies a unique service provider 54, including all versions thereof, relative to all other service providers 54 in the direct service invocation infrastructure framework architecture 50;
M represents the major version number of a service provider 54 instance (initially set to 1 and thereafter takes the highest major version number (m) of any business operation implemented through the service provider interface); and
N represents the minor version number of a service provider 54 instance (initially set to 0 and incremented with the deployment of any new version of the service provider 54 instance).

A separate identifier is also assigned to each callable business operation implemented by a service provider 54 instance. In the preferred embodiments, business operation implementation identifiers are of the form oID.m.i.p, where
oID identifies a business operation uniquely within the scope of an sID identified service provider 54;
m represents the major version number of the business operation (on initial inclusion of the business operation into the service invocation interface 62, set equal to the then major version number (M) of the service provider 54 instance; incremented whenever any breaking change, including any change to the business operation name, parameters, return type, or functional implementation, is made to the underlying business operation);
i represents the business operation interface version number (initially set to 0 and increments with any change in the interface; resets to 0 when m is incremented); and
p represents the implementation version number of the underlying business operation implementation (initially set to 0; incremented when the implementation, but not the interface, changes; reset to 0 when i is incremented).

A hypothetical progression of the service provider 54 version identification scheme is presented in Table 3.

TABLE 3
Example Version Identification Scheme Progression

| | Versioning Identifier | | | |
|---|---|---|---|---|
| | Service | Bus. | Bus. | Map |
| Action | I/F | Op. 1 | Op. 2 | Required |
| New service deployed | 78.1.0 | 4.1.0.0 | 12.1.0.0 | N |
| Implementation change | 78.1.1 | 4.1.0.1 | | N |
| Interface change | 78.1.2 | | 12.1.1.0 | Y |
| Interface change | 78.1.3 | 4.1.1.0 | | Y |
| Breaking change | 78.2.0 | | 12.2.0.0 | n/a |
| Implementation change | 78.2.1 | | 12.2.0.1 | n/a |
| Stub upgraded | 78.2.1 | 4.1.1.0 | 12.2.0.1 | N |

As indicated, the service invocation interface 62 of a new service provider 54 instance, having an assigned sID of 78, will be deployed with a service provider version identifier 78.1.0. Each time a versioned instance is deployed or redeployed, the service provider version identifier is correspondingly versioned. The relationship between the service provider version identifier and specific versioned changes to the service provider 54 are preferably recorded, at design-time, in the SIM meta-data store 116, thereby allowing the service invocation manager 112, during run-time, to determine the service proxy class 82′ and meta-data 114′ required to support direct communications between particular service requester 52 and service provider 54 instances.

Thus, for example, the service invocation manager 112 can determine acceptable differential loading of service provider 54 instances 78.1.0 and 78.1.1, where the implementation change realized by 78.1.1 instances is identified in the SIM meta-data store 116 as capable of supporting a greater number of concurrent sessions. Given the combination of the service provider version identifier, for example an identifier 78.1.2 or 78.1.3, and the known service interface stub version of a particular service requester 52 instance, the service invocation manager 112 can determine the precise business operation call mappings, conversions, and transforms required to enable the communications session for that service requester 52 instance. Corresponding meta-data 114′ is provided to the service requester 52 instance.

In the case of a breaking change, as discoverable from the design-time stored SIM meta-data based on the service provider version identifier 78.2.0, the service invocation manager 112 can determine the potential compatibility of service requester 52 instances, based on the differently versioned service interface stubs 78_{A}, 78_{B} implemented. Once all relevant service requester 52 instances have been updated to be compatible with the supported business operations, any currently deployed 78.1.X compatible service provider 54 instances can be decommissioned.

An SOA system 150 employing virtualization and grid computing elements in conjunction with the present invention is illustrated in FIG. 8. While, the virtualization and grid computing elements are not required by the present invention, the ability to use and optimally manage these elements as integral parts of the direct service invocation infrastructure framework architecture 50 of the SOA system 150 is fully contemplated. As shown, a grid computing complex of server platforms 74, generally corresponding to the servers 18, employ conventional virtualization kernels 152 and grid computing kernels 154 to host and coordinate execution of multiple guest operating system stacks 156_{1-M}. Preferably, each of the guest operating system stacks 156_{1-M} includes a guest operating system 76 enabling execution of one or more service providers 54 within an application server 72. The virtualization kernel 152 enables execution of the guest operating system stacks 156_{1-M} as discrete components. In a preferred embodiment of the present invention, Xen, an open source product supported by XenSource, Inc., Palo Alto, Calif., can be used to implement the virtualization kernel 152. Alternately, VMware ESX Server, a product of VMware, Inc., Palo Alto, Calif., can be used. An administration interface, hosted by the virtualization kernel 152, allows guest operating system stacks 156_{1-M} to be individually halted, saving state, and subsequently restarted transparently with respect to the service providers 54. A network 12_{D}, like networks 12_{A-C}, enables virtualization kernels 152 executing on different platforms 74, to autonomously coordinate the halting, transport, and restart of a guest operating system stack 156_{X} as guest operating system stack 156′_{X} on a different platform 74.

The virtualization kernel 152 administration interface is exposed to the grid kernel 154 to enable service provider resource management on the grid network connected platforms 74. Typically, the grid kernel 156 operates to manage the coordinated execution of the guest operating system stacks 156_{1-M} executing the some or substantially similar service provider 54 resource. For example, where the service provider 54 executed within a guest operating system stack 156_{X} becomes platform 74 resource limited, a functional copy, as guest operating system stack 156′_{X}, can be created and started to load share. Similarly, an underutilized guest operating system stack 156′_{X} can be terminated under the control of the grid kernel 154, leaving the guest operating system stack 156_{X} to assume responsibility for the previously shared load. In a preferred embodiment of the present invention, the grid kernel 154 is implemented using AppLogic™, a product of 3Tera, Inc., Aliso Viejo, Calif.

In accordance with the present invention, the service provider manager 118, executed on a server within the SOA system 150, such as server 16, preferably performs high-level management of server provider 54 instances and, further, supports operation of the server invocation manager 112. One or more server provider managers 118 may be utilized within the SOA system 150, as redundant system resources, to manage redundant or otherwise separate clusters of service provider platforms 74, or both. Each service provider manager 118 preferably includes an SPM server 158, preferably implemented using a conventional J2 EE-compliant application server, further allowing communications with the service invocation manager 112 and design-time developers and run-time administrators 134. The SPM server hosts service provider adapters 120_{1-Y}, preferably implemented as local modules. The service provider adapters 120_{1-Y} provide communications interfaces dedicated to the particular management and administration interfaces exposed by the specific platform 74_{1-Y}, virtualization kernel 152_{1-Y}, and grid kernel 154_{1-Y} instances implemented on the servers 18_{1-Y}.

The server provider manager 118 further implements a server provider manager core logic component 160 to manage, through the SPM server 158 and service provider adapters 120_{1-Y}, various aspects of the servers 18_{1-Y}. In particular, the SP manager core logic component 160 can preferably initiate and terminate execution of specific service providers 54, as well as monitor platform resource allocation and usage, the functional network address location of the individual service providers 54 subject to the operation of the virtual kernels 152_{1-Y}, and grid kernel 154_{1-Y} managed initiation and termination of specific existing service providers 54. Preferably, the collection of registered service providers 54 services available for execution within the SOA system 150 are persisted in the SPM meta-data store 124. Lists of the currently executing service providers and corresponding network locations are also kept current in the SPM meta-data store 124.

In the preferred embodiments of the present invention, bidirectional communications are supported between the service invocation manager 112 and service provider manager 118. The service invocation manager 112 can command the service provider manager 118 to initiate the creation and termination of service providers 54. Status changes in the servers 18, particularly including the operating availability and network location of service providers 54 are reported by the service provider manager 118 to the service invocation manager 112.

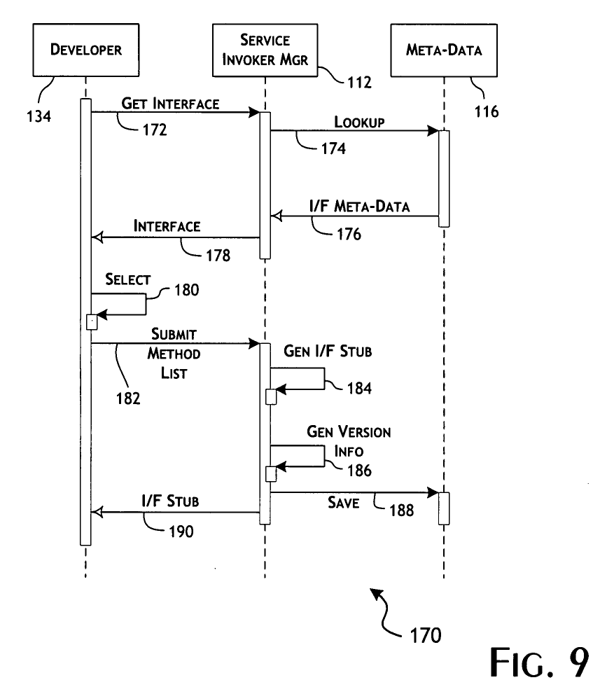

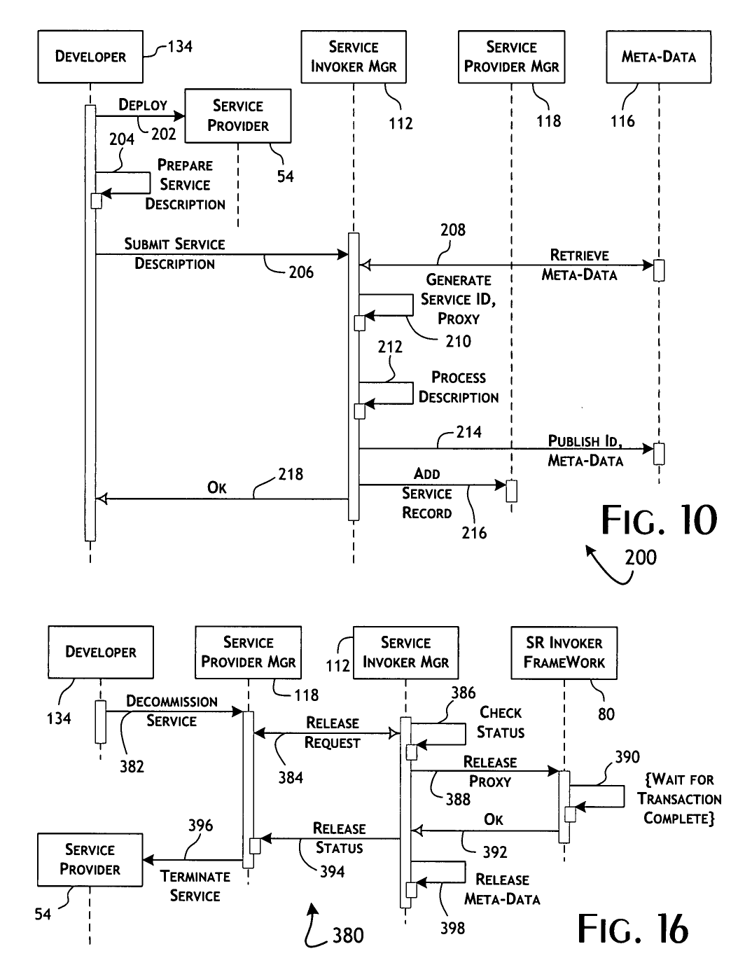

FIG. 9 illustrates the preferred process operations 170 involved in the generation of service requesters 52 capable of implementing the direct service invocation infrastructure framework architecture 50 and thus leveraging the SOA system 150. A developer 134, in development of a service requester core logic component 56, will request 172, from the service invocation manager 112, an interface definition corresponding to a desired service provider 54. The WSDL bindings or equivalent defining information corresponding to the requested interface are requested 174 and returned 176 from the meta-data store 116. The interface definition is returned 178, preferably in the form of a web-page list, to the developer 134, allowing selection 180 of all or a desired subset of interface definition methods. The service invocation manager 112 responds to submission 182 of the selection list by generating 184 a corresponding service interface stub 78. Interface version information, derived from the WSDL binding information, is also incorporated 184 into the service interface stub 78. In the preferred embodiments of the present invention, the generated service interface stub 78 is then cached 188 by the SIM meta-data store 116 with a copy being returned 190 to the developer 134. One or more different service interface stubs 78, each defined and retrieved by the operation 170, are then be utilized by the developer 134 in the further development of a service requester core logic component 56.

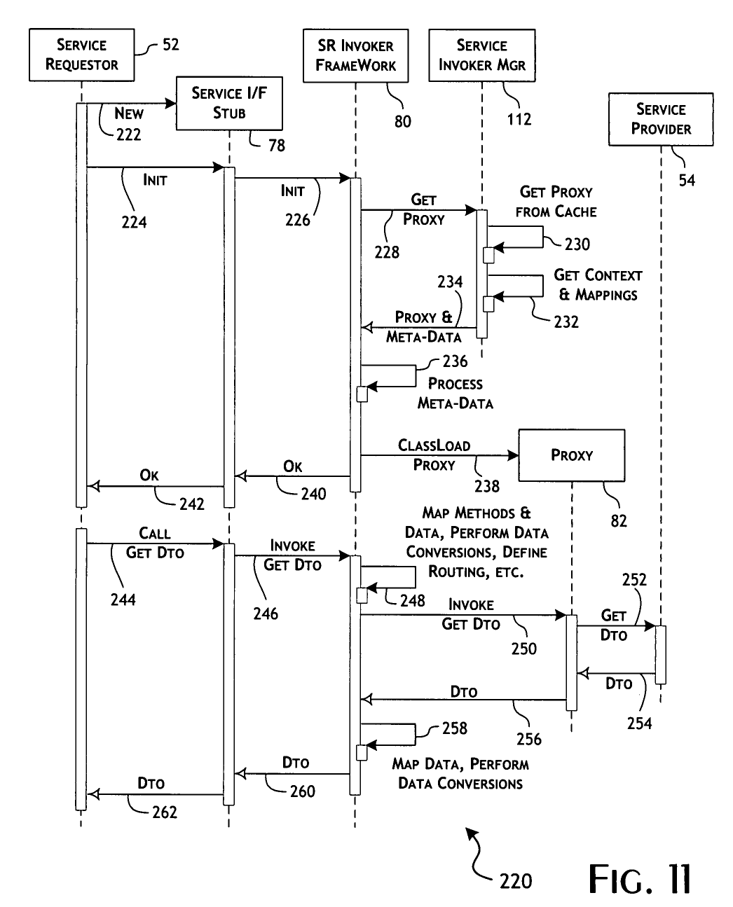

A preferred service provider 54 deployment process 200 is shown in FIG. 10. A new or updated service provider 54 is deployed 202 by transferring or otherwise enabling access by one or more of the server platforms 74 to an executable copy of the service provider 54. That is, the service provider 54 may be transferred directly to the server platforms 74 or stored in a network accessible persistent data store (not shown) for on-demand retrieval by any of the application servers 72. A service description record 204 defining the execution requirements, dependencies, management policies, WSDL URL, and administrative requirements of the service provider 54 is prepared 204 and transferred 206 to the service invocation manager 112. The description record 204 is further processed, as necessary, to a desired meta-data format and stored 208 in the SIM meta-data store 116 for use in defining and potentially constraining the availability of the service provider 54 for use by service requesters 52. The service invocation manager 112 then retrieves 208 the design-time determined service provider bindings and related information from the meta-data store 116. A unique service provider identifier is generated 210 and a corresponding proxy class 82′ then generated and cached. Service provider description records are then preferably produced 212 as the meta-data defining the different version context and mappings anticipated by the service invocation manager 112 to be needed based on the currently executing set of service requesters 52. This meta-data, associated with the unique service provider identifier, is then incorporated 214 into the meta-data store 116. The service provider 54 description record, also including the unique service provider identifier, is provided 216 to the service provider manager 118 and saved to the SPM meta-data store 124. The deployment of the service provider 54 is then finished 218.

In the preferred embodiments of the present invention, service requesters 52 are configured during run-time initialization to enable direct invocation of the service providers 54 specifically identified by the service requesters 52. The service requesters are thereafter dynamically reconfigurable in response to various circumstances, including changes in the network location, routes and availability of service providers 54. Dynamic reconfiguration also supports adaptation to versioning differences between the service requesters 52 and their directly invoked service providers 54, whether existing at run-time initialization of the service requester 52 or later occurring during the run-time of the service requester 52 due to a restart, move, versioning, or other operation affecting the state or location of a directly invoked service provider 54.

A preferred requester process operation 220, covering the initialization of a service invocation framework component 80 by a service requester 52 and subsequent use to directly invoke a service provider 54, is shown in FIG. 11. Within a service requester 52, typically initial execution of the included service requester core logic component 56 results in the loading 222 and initialization 224 of an embedded class implementing a service interface stub 78. An initialization call 226 provides an interface identifier to the local service requester invocation framework component 80. A corresponding service proxy class 82 is requested 228 from the service invocation manager 112. The default network location of the service invocation manager 80 is preferably encoded into the service requester 52. Alternately, an identifier sufficient to allow run-time discovery of the service invocation manager 80 network location is provided either encoded or as a run-time start-up parameter to the service requester 52. The requested service proxy class 82 is either retrieved 230 from the proxy cache 138 or generated by the proxy generation engine 136. Execution context data and any additional mapping, conversion and translation meta-data are retrieved 232 from the SIM meta-data store 116 and returned 234 as the service proxy class 82′ and meta-data 114′ to the service requester invocation framework component 80. The service proxy class 82′ and meta-data 114′ are incorporated 236, 238 into the service requester invocation framework component 80 to define and enable the direct invocation operation of the service requester invocation framework component 80.

In the preferred embodiments of the present invention, a classloader mechanism enables the service requester invocation framework component 80 to dynamically and discretely host and replace one or more service proxy classes 82 during the run-time of the service requester 52. Dynamic run-time reconfiguration of the service requester 52 occurs in response to a reconfiguration event, such as due to the receipt of an administrative reconfiguration message issued from the service invocation manager 112. In response to a reconfiguration event, the service requester invocation framework component 80 will re-request 228 a service proxy class 82 from the service invocation manager 112. Where the administrative reconfiguration message functionally identifies a specific service interface stub 78, the corresponding service proxy class 82 is requested. Otherwise, service proxy classes 82 are requested for all of the service interface stubs 78 supported by the service requester 52. The service invocation manager 112 can then return 234 service proxy classes 82′ and SIM meta-data 114′ or only SIM meta-data 114′. In the latter instance, the service invocation manager 112 can determine that a replacement service proxy class 82 is not required, but rather the existing service proxy class 82 is appropriate or can be updated by the service requester invocation framework component 80 using configuration data provided as part of the SIM meta-data 114′. For the preferred embodiments, replacement of a service proxy class 82 will depend on whether the service proxy class 82 implements a required configuration update as a programmable or compiled value and whether a version change has occurred in the service invocation interface of the corresponding service provider 54.

Nominally, data is transferred between a service requester core logic component 56 and service provider core logic component 60 is encapsulated as parameter and return objects, generically referred to as data transfer objects (DTOs), subject to a data transfer request, characteristically a called business operation requiring transfer of structured data. While DTOs may be transferred as parameter and return values unidirectionally or bidirectionally dependent on the specifics of a particular read or write request, the request process, for purposes of the present invention, is otherwise the same. Referring again to FIG. 11, an exemplary read data transfer request is initially issued by a service requester core logic component 56 as a business method call through 244 the service interface stub 78. In the preferred embodiments of the present invention, a reflection mechanism is utilized to invoke 246 the service requester invocation framework component 80 with the parameters of the data transfer request. The service requester invocation framework component 80 may perform 248 method name, parameter, and return value mapping, conversion and translation operations to functionally adapt the business method call to the business operation interface requirements of the intended service provider 54.

A reflection-based invocation 250 then applies the data transfer request, as potentially modified, to the service proxy class 82. In response, the service proxy class 82, typically through interoperation with the communications resources available through the application server 72, directs the issuance 252 of the data transfer request as a business operation call, in the form of a web services, J2EE, JMS, REST, other request, specific to the service invocation interface 62 of the intended service provider 54. The web services request is directed to the network location specified as configuration data incorporated into the service proxy class 82 or as determined from the SIM meta-data 114.

In an alternate embodiment of the present invention, the service proxy class 82 can also implement mapping, conversion and translation operations, preferably where the implementation of such operations are particularly unique to a service provider 54, determined to be required after deployment of the service requester invocation framework component 80, or not readily expressed as meta-data for purposes of efficient implementation.

As processed by and through the service provider core logic component 60, the data transfer request may return a new DTO or updated parameter DTO. In the preferred embodiments of the present invention, a data request response as typically coupled with DTO is processed through the application server 72 with the result that the DTO is returned 254 to the service proxy class 82. The service proxy class 82 may, in an alternate embodiment, perform reverse mapping, conversion and translation operations defined by the service proxy class 82, including SIM meta-data 114 incorporated into the service proxy class 82. The DTO is then returned 256 to the service requester invocation framework component 80 where any reverse mapping, conversion, and translation operations defined by the SIM meta-data 114 are then performed 258. The DTO is further returned 260 to the service interface stub 78. Finally, an ordinary call return 262 delivers the DTO to the service requester core logic component 56.

A preferred process 270 for determining and applying the mapping, conversion and translation operations 248, 258 is shown in FIG. 12. For the preferred embodiments of the present invention, a mapping processor 272 is implemented as part of the proxy generation engine 136 within the service invocation manager 112. WSDL binding information obtained from the SIM meta-data store 116 enables definition of an interface map 274 that describes a transform between the called business methods 276 of a specific service interface stub 78 and the corresponding called business operations implemented through a service invocation interface 62. Preferably, the SIM meta-data store 116 contains service interface stub 78 method descriptors 280 as defined in Table 3.

TABLE 3
Service Interface Stub Method Descriptors

| Data | Description |
|---|---|
| Version Number: | A major and minor version number; relates a |
| | collection of method descriptors to a specific |
| | Service Interface Stub instance. |
| Name: | Method descriptor name. |
| Signature: | The method signature, including parameter count and |
| | order specification, of the service interface stub |
| | method described by this descriptor. |
| Object Types: | The data types of the parameter and return data |
| | values for the service interface stub method |
| | described by this descriptor. |
| Attribute Data: | Attribute definitions further qualifying the object type |
| | definitions for the service interface stub method |
| | described by this descriptor; broadens the analysis |
| | scope in determining permitted data conversions |
| | and translations. |

The SIM meta-data store 116 preferably provides service interface business operation descriptors 282 to the mapping processor 272. The service interface business operation descriptors 282 are preferably as defined in Table 4.

TABLE 4
Service Interface Business Operation Descriptors

| Data | Description |
|---|---|
| Version Number: | A major and minor version number; relates a |
| | collection of business operation descriptors to a |
| | specific Service Invocation Interface instance. |
| Name: | Operation descriptor name. |
| Signature: | The method signature, including parameter count and |
| | order specification, of the service invocation |
| | interface operation described by this descriptor. |
| Object Types: | The data types of the parameter and return data |
| | values for the service invocation interface operation |
| | described by this descriptor. |
| Attribute Data: | Attribute definitions further qualifying the object type |
| | definitions for the service invocation interface |
| | operation described by this descriptor; broadens |
| | the analysis scope in determining permitted data |
| | conversions and translations. |

An interface map 272 is autonomously determined by the mapping processor given the service interface stub 78 and exposed API service invocation interface 62 business operation version numbers of a specific instance of a service provider 54 that is to be directly invoked by a specific instance of a service requester 52. The signature method and business operation names are matched or resolved to pairings based on the attribute data, rearrangements and paddings of parameters are determined based on data type or attribute data identified associations, and parameter and return value data-type conversions are specified based on inheritance or to use attribute data identified library routines.

In the preferred embodiments of the present invention, the collected meta-data representing an interface map 272 is parsed, compiled, and stored in the SIM meta-data store 116, pending run-time retrieval as SIM meta-data 114′ and, in an alternate embodiment of the present invention, run-time incorporation into a corresponding service proxy class 82′. As appropriate, configuration data related to the use of the SIM meta-data 114′ by a service requester invocation framework component 80 is also stored in the SIM meta-data store 116.

A preferred interoperation process 290 between the service invocation manager 112 and service provider manager 118, as shown in FIG. 13, allows service requesters 52 to dynamically discover and directly invoke desired service providers 54. Dynamic discovery will be performed at run-time start-up operation of the service requesters 52 as well as dynamically in response to reinitialization commands issued by the service invocation manager 112 generally to implement behavioral and policy changes in ongoing operation of the service requesters 52. These changes may be made to manage use of the currently deployed set of service providers 54, particularly in response to versioning changes, and to adjust the load-balancing, fail-over, quality of service, and other system management policies defined through the distributed meta-data 114 and proxy classes 82. Thus, whenever a service requester invocation framework component 80 is required to initialize or reinitialize, the service requester invocation framework component 80 will request 228 meta-data 114′ and one or more service proxy classes 82′ corresponding to the desired set of service providers 54. As an efficiency for repeated reinitialization to switch between different instances of a service provider 54, the service requester invocation framework component 80 may and preferably does cache previously received proxy classes 82 and associated meta-data 114. In such cases the command for reinitialization will specify whether any locally cached proxy class 82 and meta-data 114 is to be invalidated. Where previously cached and not invalid, the proxy class 82 portion of the request 228 can then be satisfied local to the service requester invocation framework component 80.

When the request 228 is serviced by the service invocation manager 112, the proxy cache 138 is preferably first checked 230 for a suitable service proxy class 82. If a service provider 54 corresponding to the desired service provider 54 identified by the service requester invocation framework component 80 is not already executing, a start service request is sent 292 to the service provider manager 118. An execution context and associated run-time meta-data are determined 294 by the service provider manager 118. A context corresponding service provider adapter 120 instance is identified, if already executing, or started 296. In turn, the context determined platform provider 72, 74, 152, 154 will be contacted 298 to direct the start 300 of the desired service provider 54 instance in the determined context, depending on whether a suitable service provider 54 is already executing within the SOA system 150 as determined by the service provider manager 118. The nature of the platform provider 72, 74, 152, 154, specifically whether either or both a virtualization kernel 152 and grid kernel 154 are implemented on the platform 72, will be reflected in the instance choice of the service provider adapter 120, thereby facilitating the proper monitoring and management of the service provider 54 instance.

The context, including the network location of the service provider 54 instance, is returned 302, 304 through the service provider manager 118 to the service invocation manager 112. The interface map 274 and associated meta-data 114′ is developed 232 and, as needed, service proxy classes 82′ are retrieved from the proxy cache 138, as determined by the service invocation manager 112. As before, any required service proxy class 82′ and SIM meta-data 114′ are then returned 234 and dynamically incorporated 236, 238 by the service requester invocation framework component 80.

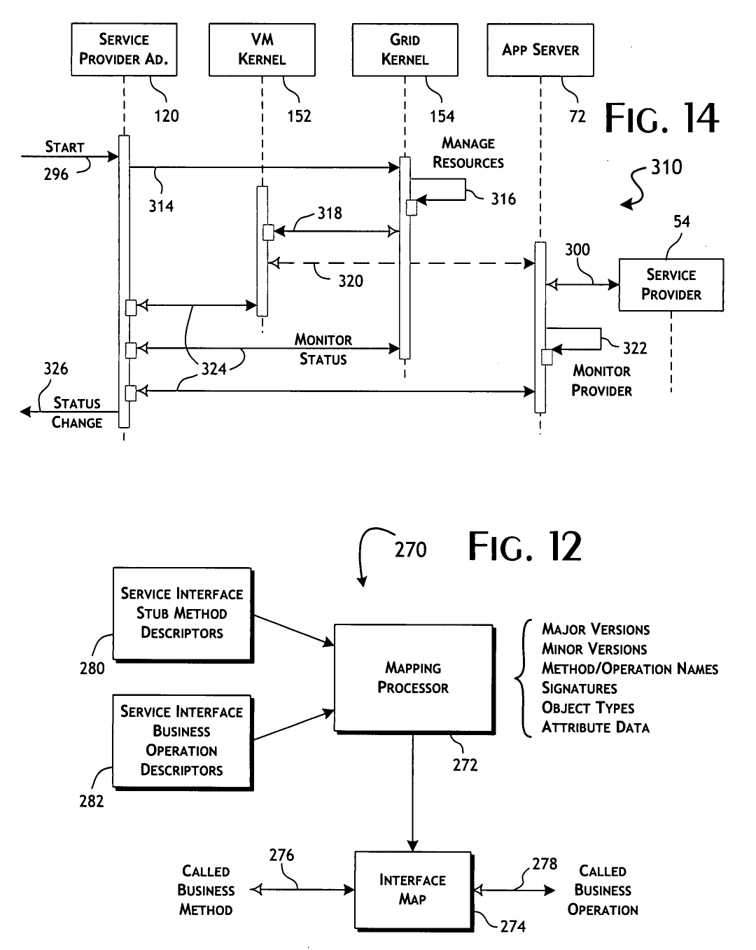

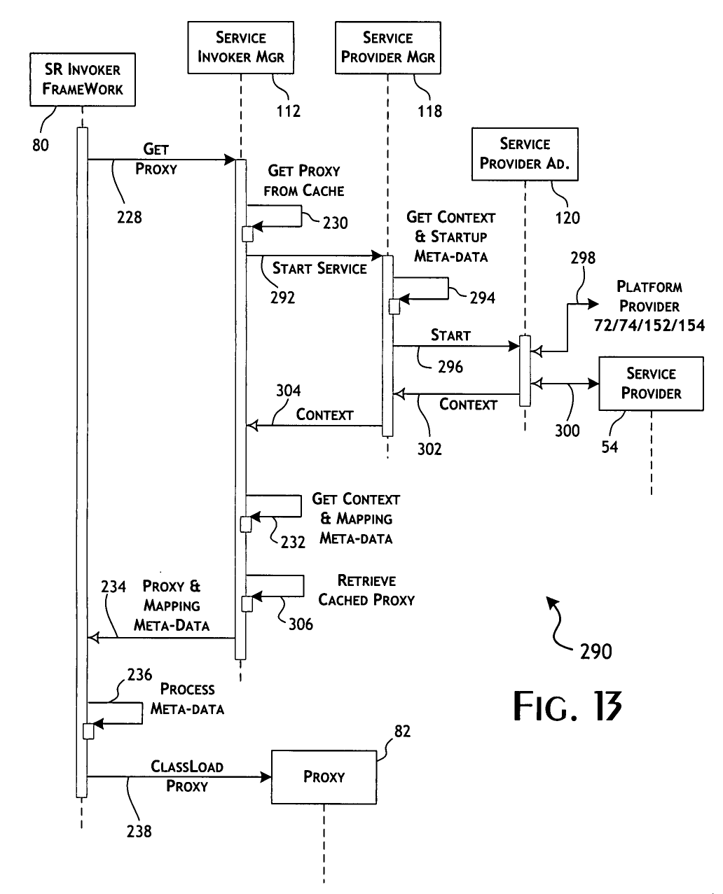

In a preferred embodiment characteristically useful where the SOA system 150 includes a larger number of often disparate types of platforms 74 and further incorporate various combinations of virtualization 152 and grid 154 kernel components, the multiple instances of the service provider adapters 120 are preferably used to simplify interoperation with the particular platform provider 72, 74, 152, 154 combinations. As shown in FIG. 14, an exemplary service provider adapter interoperation process 310 enables administrative integration with a platform provider implementing virtualization 152 and grid 154 kernels to execute an application server 72 within a guest operating system stack 156. Where, as before, a start service request 296 is received by the service provider adapter 120, an initial service request 314 is submitted to the grid kernel 154. Depending on the available resources and the defined grid computing policies established for the grid kernel 154, the start service request is administratively passed 318 to a selected virtualization kernel 152 to create or select 320 a guest operating system stack 156 instance for executing the application service 74 instance to start or verify 300 execution of the desired service provider 54 instance. The various service provider 54 instances executed within a particular application server 72 instance are continually monitored 322.

Concurrently, the service provider adapter 120 instance monitors 324 for changes in the administrative state of the virtualization 152 and grid 154 kernels and application server 72 instances under management by the particular service provider adapter 120 instance. In particular, the start-up or other change of status in the execution of a service provider 54 instance, such as changed network location, the associated operation of the application server 72, grid kernel 154 and virtualization kernel 152, is reported through the service provider adapter 120 to the service provider manager 118 as changed context data 302. The context and related information are updated 324 to the SPM meta-data store 124 for future reference. The context, particularly including the network location of the service provider 54, is then returned 304 to the service invocation manager 112 and, in turn, to a service requester 52 to enable direct invocation.

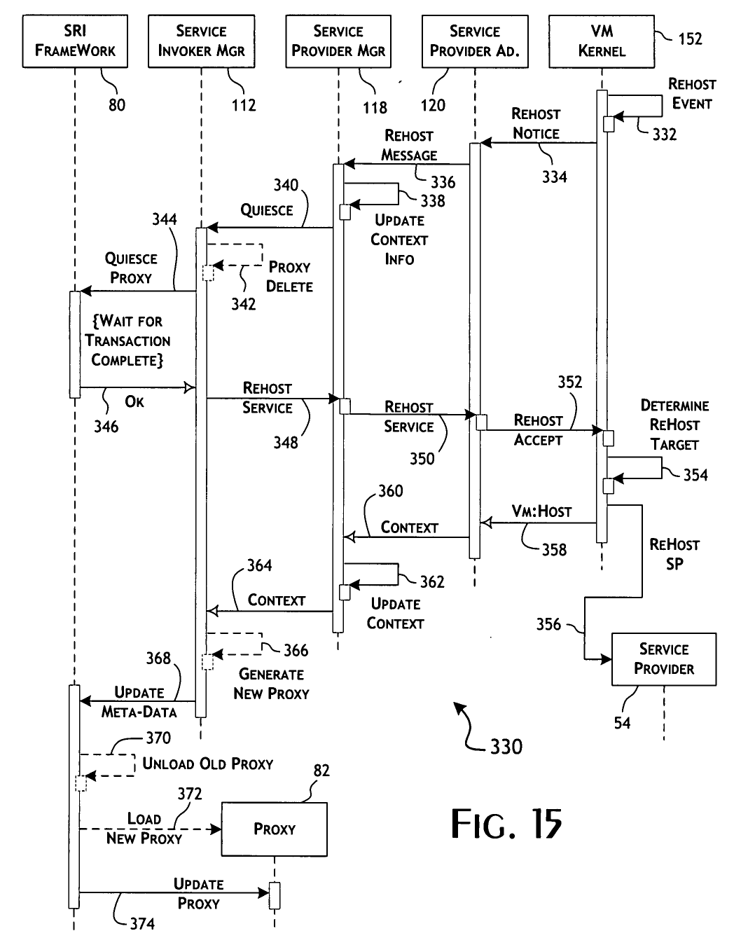

Virtualization kernels 152, alone or in combination with grid kernels 154, support the relocation of guest operating system stacks 156, resulting in a potential change in the network location of hosted service providers 54. As illustrated in FIG. 15, a rehost event notification is typically available through the administrative interface of the virtualization kernel 152. The rehost event may be generated 332 in response to autonomous control operations defined internal to the virtualization kernel 152, in response to command operations from the grid kernel 154, for example as appropriate to implement distributed resource management, or as a consequence of management commands issued by the service provider manager 118.

In a preferred embodiment of the present invention, the rehost event occurs prior to the relocation or similar change to a guest operating system stack 156. Rehost notices are listened for 334 by corresponding service provider adapters 120 and passed as a message 336 to the service provider manager 118. The corresponding service provider context status is updated 338 in the SPM meta-data store 124 and a quiesce message is forwarded 340 to the service invocation manager 112. Where the rehost event follows from the deployment of a versioned service provider 54, an existing service proxy class 82′ may be deleted 342 from the proxy cache 138. Deletion is typically conditioned on whether any applicable non-decommissioned service providers 54 remain in the SOA system 150. That is, the present invention allows differently versioned instances of otherwise the same service provider to coexist within the SOA system 150.

Based on information retrieved from the SIM meta-data store 116, the service invocation manager 112 identifies each of the service requesters 52 established to directly invoke the affected service provider 54. Quiesce proxy messages are sent 344 to the service requester invocation framework component 80 of each such service requester 52. In turn, the service requester invocation framework component 80 return 346 an OK message as all currently pending transactions through the service proxy classes 82 have completed. A rehost service message is then sent 348, 350, 352 through to the virtualization kernel 152, to enable the otherwise ordinary completion of the rehost operation, including typically the determination 354 of a rehost target location and corresponding transport 356 of the service provider 54.

Nominally, a rehost completion message is then generated 358 and transferred through the service provider adapter 120 to provide 360 updated context and network location information to the service provider manager 118. After updating 362 the SPM meta-data store 124, this information is further provided 364 to the service invocation manager 112. For a versioning dependent rehosting, a new service proxy class 82′, as required to reflect the specific versioning change, is retrieved 366 from the proxy cache 138. Changed context dependent SIM meta-data 114′ and any required new service proxy class 82′ are then provided 368 to the service requester invocation framework components 80 of the affected service requesters 52. Where a new service proxy class 82′ is provided, the prior version service proxy class 82 is unloaded 370 and the new version service proxy class 82 is loaded 372. The meta-data 114 and, as applicable, the service proxy class 82, are then updated 374, again allowing direct invocation of the corresponding service provider 54.

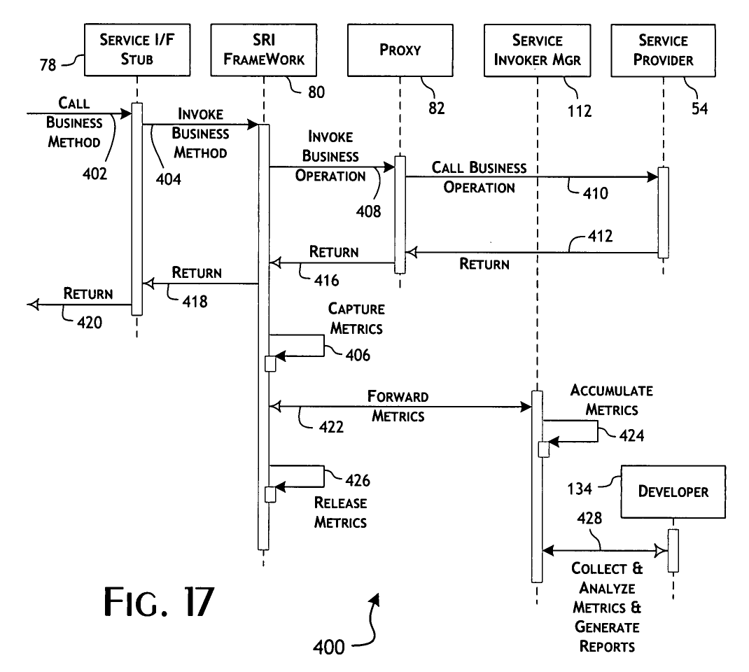

In the ongoing operation of a SOA system 150, multiple instances of a service provider 54 may be in use by various different service requesters 52. In addition to coexisting, different service provider 54 instances can implement different versions of the service invocation interface 62. Preferably, as a default policy, the service provider interface stub generation process 170 will not generate a new service interface stub 78 for a deprecated business operation. Through ongoing maintenance, service requesters 52 will migrate to using later if not latest versioned service providers 54. Prior versioned service providers 54 may still be subject to use by service requesters 52 capable of using later versioned service providers 54. A service provider decommissioning process 380, as shown in FIG. 16, is supported by preferred embodiments of the present invention to force a prior version of a service provider 54 out of service within the supported scope of the SOA system 150. An administrator or developer 134, on determining to decommission a specific version of a service provider 54, issues a service provider decommissioning command typically to the service provider manager 118.

The service provider manager 118, upon determining the affected service providers 54, specifically the service providers 54 in current execution that implement the decommission command specified version of the service providers 54, release requests are sent 384 to the service invocation manager 112. In response, the service invocation manager 112 determines 386 the specific affected service providers 52 and commands 388 the corresponding service requester invocation framework components 80 to release the service proxy classes 82 specific to the deprecated service providers 54. As outstanding transactions complete 390, the service requester invocation framework components 80 acknowledge 392 termination of the dependency on the decommissioning service providers 54. Once all acknowledgments are received, a release request status message is returned 394 to the service provider manager 118. The decommissioned service providers 54 are then terminated. The decommissioned service provider corresponding meta-data 114 and service proxy class 82 can then be deleted 398 from the meta-data store 116 and proxy cache 138.

If not immediately commanded by the service invocation manager 112 to reinitialize, a service requester core logic component 56 will, subsequent to the release of an affected service proxy class 82, eventually issue a business method call through a corresponding service interface stub 78. In turn, the local service requester invocation framework component 80 will, transparently with respect to the service requester core logic component 56, then initiate the interoperation process 290 to acquire and install a new service proxy class 82. Within the interoperation process 290, the service invocation manager 112 provides a service proxy class 82′ appropriate for a currently commissioned version of the requested service provider 54. The version of the service provider 54 selected for use by the requesting service requester 52 will depend on the specific instance of the service provider 54 selected by the service provider manager 118 preferably as based on load-balancing, latency, and other policy factors, including administrative considerations such as differential performance and management benefits associated with particular versions of a service provider 54.

In accordance with the present invention, the direct invocation of service providers 54 by service requesters 52 avoids the latencies and other disadvantages of centralized distribution of service operation requests as occurs with the conventional use of an ESB 32. Performance and other metrics, otherwise conventionally gathered in-band by an instrumentation of the ESB 32, are effectively accumulated and processed out-of-band by the service invocation manager 112 in preferred embodiments of the present invention. Referring to FIG. 17, a metrics acquisition and processing process 400, as implemented in preferred embodiments, utilizes the distributed service requester invocation framework components 80 to capture and forward operational metrics to the service invocation manager 112. With each business method call 402 on the service interface stub 78, a corresponding business method is invoked 404 on the local service requester invocation framework component 80. Administratively defined metrics are incrementally captured 406 with inconsequential delay or performance impact on the further invocation 408 of the corresponding business operation through the service proxy class 82 and direct invocation 410 of the corresponding service provider 54. Further incremental metrics are captured 406 on the business method invocation return 412, 416.

The metrics locally collected by the distributed service requester invocation framework components 80 are separately forwarded 422 to and accumulated 424 by the service invocation manager 112. The basic metrics forwarding 422 timing is defined administratively, preferably as a value provided as part of the meta-data 114 to the service requester invocation framework components 80 and potentially different for different service requesters 52. Metrics forwarding 422 is further implemented as a relatively low priority background task of the service requester invocation framework components 80, allowing forwarding to be deferred as needed to avoid degradation of the in-band direct invocation of service providers 54. The locally collected metrics, as stored on the individual service requesters 52, are preferably released 426 by action of the service requester invocation framework components 80. A release 426 is preferably performed in response to a successful forwarding transfer 422 or incrementally as the collected metrics exceeds a defined storage size.

Once forwarded to the service invocation manager 112, analysis and reporting 428 of the metrics occurs effectively out-of-band with respect to the ongoing operation of the service requesters 52. Given the small size and relatively small required overhead of locally collecting and forwarding the metrics to the service invocation manager 112, the presentation of metrics is still achieved in near real-time, at least for the practical needs of administrators and developers 134.

Thus, an improved distributed computer system infrastructure enabling an efficient direct invocation of services, subject to dynamic versioning, within the cooperative organization of a service-oriented architecture and methods of operation has been described. In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer implemented method of dynamically managing version compatibility among service requesters and service providers within a service-oriented architecture as implemented by a distributed computer system, said method comprising the steps of:
a) recording, in a database by a service manager, correspondence data relating fixed service request interface identifiers with business operation service interface identifiers;
b) processing, by said service manager, a request to associate a predetermined service requester, having a predetermined fixed service request interface identifier, with a predetermined service provider, having a predetermined business operation service interface identifier, wherein said step of processing includes
i) obtaining said correspondence data for said predetermined fixed service request interface identifier and said predetermined business operation service interface identifier;
ii) determining from said correspondence data whether said predetermined service requester and said predetermined service provider are compatible; and
iii) providing said predetermined service requester with predetermined configuration data where said predetermined service requester and said predetermined service provider are compatible; and
c) dynamically adapting, by said predetermined service requester, a fixed service request interface of said predetermined service requester to correspond with a business service interface of said predetermined service provider.

2. The computer implemented method of claim 1 wherein said step of dynamically adapting includes installing said predetermined configuration data to establish an operative mapping of requests and responses exchanged between said fixed service request interface of said predetermined service requester and said business service interface of said predetermined service provider.

3. The computer implemented method of claim 2 wherein said predetermined configuration data is determined by relation of said predetermined fixed service request interface identifier and said predetermined business operation service interface identifier, where said service provider version identifier represents a predetermined encoding of business operation identifiers established in correspondence with a plurality of business operation services implemented said predetermined service provider, said predetermined configuration data being determined by relating said predetermined encoding of business operation identifiers and said predetermined business operation service interface identifier.

4. The computer implemented method of claim 3 wherein said predetermined configuration data defines the associations and conversion requirements of service requests and responses as transferred between said fixed service request interface of said predetermined service requester and said business service interface of said predetermined service provider.

5. A computer implemented method of dynamically managing version compatibility among service requesters and service providers within a service-oriented architecture as implemented by a distributed computer system, said method comprising the steps of:
a) monitoring, by a service manager, the status of a plurality of service providers deployed for execution within a distributed computer system, to detect a change in a business services interface respectively implemented by said plurality of service providers;
b) first determining, by said service manager in response to a detected change in said business services interface for a predetermined service provider, an encoded service identifier corresponding to said business services interface as changed;
c) second determining, by said service manager, mapping and transformation meta-data from said encoded service identifier and an identifier of a service request interface implemented by a predetermined service requester;
d) providing, by said service manager, said mapping and transformation meta-data to said predetermined service requester; and
e) dynamically incorporating, by said predetermined service requester, said mapping and transformation meta-data to operatively convert service requests and responses as transferred between said service request interface of said predetermined service requester and said business services interface of said predetermined service provider.

16. The computer implemented method of claim 5 further comprising the step of analyzing, by said service manager, associations between a plurality of encoded service identifiers and identifiers of service request interfaces, said step of analyzing determining compatible associations and storing, in a database for each compatible association, corresponding mapping and transformation meta-data.

17. A computer implemented method of dynamically managing version compatibility among service requesters and service providers within a service-oriented architecture as implemented by a distributed computer system, said method comprising the steps of:
a) storing, in a database accessible by a service invocation management computer system, for each of a plurality of service providers, a respective first set of first business operation identifiers, wherein each said first business operation identifier is defined with respect to a version of a business operation implementation of said plurality of service providers;
b) receiving a second set of second business operation identifiers, wherein each said second business operation identifier defines a business operation request implemented by a service requester, and wherein each said second business operation identifier has a potentially defined correspondence with said first business operation identifiers;
c) first determining a compatible service provider from said plurality of service providers, wherein said second business operation identifiers of said second set have respective defined correspondence with said first business operation identifiers of said compatible service provider; and
d) second determining, for each of said second business operation identifiers, mappings between said business operation requests identified by said second set and a subset of said business operation implementations of said compatible service provider; and
e) returning said mappings and an identification of said compatible service provider in response to said step of receiving.

8. The computer implemented method of claim 7 wherein said first and second business operation identifiers each include a business operation identifier and a version identifier and wherein, within the scope of said distributed computer system, said business operation identifiers uniquely identify all versions of a respective business operation and wherein, within the scope of corresponding said business operation identifier, said version identifiers uniquely identify a specific implementation version of said respective business operation.

9. The computer implemented method of claim 8 wherein said database further stores signature information with respect to said first and second business operation identifiers and wherein said step of second determining determines said mappings based on said signature information.

10. The computer implemented method of claim 9 wherein said step of returning returns, as part of said identification, a location identifier of said compatible service provider.

11. The computer implemented method of claim 10 further comprising the step of communicating directly, by said service requester, with said compatible service provider based on said mappings and said location identifier.

12. A computer implemented method of dynamically managing version compatibility among service requesters and service providers within a service-oriented architecture as implemented by a distributed computer system, said method comprising the steps of:
a) monitoring, by a service manager, the status of a first plurality of service providers and a second plurality of service requesters, wherein said service providers implement respective first sets of first business operation methods and wherein said service requesters implement second sets of second business operation requests;
b) identifying, by said service manager in response to a version change in said first set of business operation methods of a first service provider, a second service requester defined to directly communicate with said first service provider;
c) determining, by said service manager, mapping data defining conversion between said second set of business requests of said second service requester to said first set of business operation methods of said first service provider; and
d) providing, to said second service requester, said mapping data, wherein said second service requester incorporates said mapping data to enable said second service requester to directly communicate with said first service provider in conformance with said version change.

13. The computer implemented method of claim 12 further comprising the step of evaluating respective signatures of said second set of business requests of said second service requester and of said first set of business operation methods of said first service provider to establish said mapping data.

14. The computer implemented method of claim 13 wherein said service manager includes a meta-data database and wherein said step of evaluating is performed in response to said step of identifying, and wherein said step of evaluating provides for the storage of said mapping data in said meta-data database.

15. The computer implemented method of claim 14 wherein said business operation methods and said business operation requests have respectively associated business operation identifiers, wherein, within the scope of said distributed computer system, said business operation identifiers uniquely identify all versions of respective business operation methods and wherein said step of evaluating associates said business operation methods and said business operation requests of said first and second sets based on said business operation identifiers.

16. The computer implemented method of claim 15 wherein said business operation identifiers include version identifiers, wherein, within the scope of a corresponding said business operation identifier, said version identifiers uniquely identify specific versions of said respective business operation methods, and wherein said step of evaluating determines said mapping data based on differences between said version identifiers associated with said first and second sets.

17. A computer implemented method of managing the run-time use of service providers subject to versioning of the business operation methods provided, said method comprising:
a) maintaining, with respect to a collection of service providers deployed as components of a distributed computer system implementing a service-oriented architecture, a versioning database storing data representing a first plurality of service requester interfaces and a second plurality of service providers, wherein said data representing each said service requester interface includes a first set of business operation method version identifiers, wherein said data representing each said service provider includes a second set of business operation method version identifiers, and wherein said data includes mapping data defining mapping compatible correspondences between select business operation method identifiers of said first and second sets;
b) resolving, in response to a request identifying a predetermined service requester interface, a result set of service providers corresponding to said second sets of business operation method version identifiers that respectively include said first set of business operation method version identifiers corresponding to said predetermined service requester interface, wherein inclusion is defined as a mapping compatible correspondence between business operation method identifiers of said first and second sets; and
c) returning, in response to said request, result data including identification data for each service provider of said result set and mapping data, corresponding to said first set of business operation method version identifiers of said predetermined service requester interface for each service provider of said result set.

18. The computer implemented method of claim 17 wherein said step of maintaining is performed dynamically to reflect run-time changes in said collection of service providers, wherein said step of resolving is performed on-demand to enable adaptation of a predetermined service requester, including said predetermined service requester interface, to run-time changes in said collection.

19. The computer implemented method of claim 18 wherein the mapping compatible correspondences of said mapping data defines mapping conversions between business operation methods identified within said data as non-breaking.

20. The computer implemented method of claim 19 wherein said business operation method version identifiers encode a relative breaking status.
